(19) United States
(12) Patent Application Publication
(10) Pub. No.: US 2007/0290975 A1
(43) Pub. Date: Dec. 20, 2007

(54) Method for driving reflective liquid crystal display and apparatus for driving reflective liquid crystal display

(75) Inventors: Taijyu Gan, Kanagawa (JP); Hiroshi Arisawa, Kanagawa (JP); Haruo Harada, Kanagawa (JP); Yasunori Okano, Kanagawa (JP); Makoto Gomyo, Kanagawa (JP); Masahiro Sato, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/605,221

(22) Filed: Nov. 29, 2006

(30) Foreign Application Priority Data
Jun. 19, 2006 (JP) P2006-169201

(51) Int. Cl. G09G 3/36

(52) U.S. Cl. 345/94

(57) ABSTRACT

A method for driving a reflective liquid crystal display having a selective reflection layer to record an image on the reflective liquid crystal display is provided. The method includes: selectively applying two or more kinds of voltages, which includes a voltage V1_{H} exceeding an operation threshold value of the selective reflection layer and a voltage V1_{L} not exceeding the operation threshold value of the selective reflection layer, to the selective reflection layer for a period of time T_{V1}, so as to select, in the selective reflection layer, an area where the operation threshold value is exceeded and other area where the operation threshold value is not exceeded; and applying a voltage V2 to the selective reflection layer, the voltage V2 having a frequency differing from that of the voltages V1_{H} and V1_{L}.

### BACKGROUND

(i) Technical Field

The present invention relates to a driving method and a driving apparatus for writing an image on a reflective liquid crystal display which displays and records images of two or more colors formed from a plurality of selective reflection layers including liquid crystal.

(ii) Related Art

In the interest of environment conservation such as conservation of forest resources, improvements in an office environment such as space saving, and the like, great expectations are placed on a rewritable marking technique serving as a hard-copying technique which is a substitute for paper.

Meanwhile, a reflection-type liquid crystal display element does not require a custom-designed light source, such as a backlight; consumes little power; and can be configured to be flat and compact. For these reasons, attention is paid to the reflective liquid crystal display as a display device for use with compact information equipment, a portable information terminal, and the like.

In relation to the rewritable marking technique, various techniques utilizing a reflective liquid crystal display have been proposed. For example, a threshold-value shifting method has been proposed.

The principle of writing and displaying an image through use of the threshold shift method will now be described.

FIG. 24 is a diagrammatic cross-sectional view for describing the manner of writing an image according to the threshold shift method. In a stacked optical modulation element 101, chiefly two display layers 107a and 107b, which are formed from cholesteric liquid crystal, are sandwiched in a stacked manner between a transparent electrode pair consisting of transparent electrodes 105, 106.

Cholesteric liquid crystal having positive dielectric anisotropy exhibits three states: namely, a planar texture in which helical axes become perpendicular to the surface of a cell to thus induce the above-described phenomenon of selectively reflecting incident light as shown FIG. 25A; a focal conic texture in which helical axes become essentially parallel to the surface of a cell to thus permit transmission of incident light while the incident light is slightly scattered forward as shown in FIG. 25B; and a homeotropic texture in which the helical structures become untied and liquid crystal directors are oriented in the direction of an electric field to thus allow essentially-perfect transmission of incident light.

Of the above three textures, the planar texture and the focal conic texture can be bistably present in a field-free state. Consequently, the texture of cholesteric liquid crystal is not uniquely determined with respect to the strength of an electric field applied to a liquid crystal layer. When the planar texture is an initial state, the texture changes from the planar texture, the focal conic texture, and the homeotropic texture, in this sequence with an increase in field strength. When the focal conic texture is an initial state, the texture changes from the focal conic texture to the homeotropic texture in this sequence in accordance with an increase in the strength of the electric field.

When the strength of the electric field applied to the liquid crystal layer is abruptly reduced to zero, the planar texture and the focal conic texture remain intact, and the homeotropic texture changes to the planar texture.

Consequently, immediately after application of a pulse signal the cholesteric liquid crystal layer exhibits a switching behavior such as that shown in FIG. 26. When the voltage of the applied pulse signal is Vfh. 90 or more, there is achieved a selective reflection state obtained as a result of the homeotropic texture having changed to the planar texture. When the voltage ranges between Vfh. 10 and Vpf. 10, a transmission state realized by the focal conic texture is achieved. When the voltage is Vpf. 90 or less, a state realized before application of the pulse signal becomes continual; namely, the selective reflection state realized by the planar texture or the transmission state realized by the focal conic texture is achieved.

In the drawing, the vertical axis represents normalized reflectance. Reflectance is normalized on the assumption that the maximum reflectance is 100 and that the minimum reflectance is zero. Transition states exist among the planar texture, the focal conic texture, and the homeotropic texture. Accordingly, a case where the normalization reflectance assumes a value of 90 or more is defined as a selective reflection state. A case where the normalization reflectance assumes a value of 10 or less is defined as a transmission state. In relation to a threshold voltage for a texture change between the planar texture and the focal conic texture, Vpf. 90 is achieved at one end of a transition region, and Vpf. 10 is achieved at the other end of the same. In relation to a threshold voltage for a texture change between the focal conic texture and the homeotropic texture, Vfh. 10 is achieved at one end of a transition region, and Vfh. 90 is achieved at the other end of the same.

Particularly, in a liquid crystal layer having a PNLC (Polymer-Networked Liquid crystal) structure formed by doping cholesteric liquid crystal with a polymer or a PDLC (Polymer-Dispersed Liquid crystal) structure, bistability in a field-free state achieved between the planar texture and the focal conic texture is enhanced by means of interference (an anchoring effect) arising in the interface between the cholesteric liquid crystal and the polymer, and the state achieved immediately after application of the pulse signal can be maintained over a long period of time.

The stacked optical modulation element of this technique provides a color display with a memory characteristic in a field-free state, by means of taking, as an independent layer, (A) a selective reflection state realized by the planar texture and (B) a transmission state realized by the focal conic texture by utilization of the bistable phenomenon of the cholesteric liquid crystal; and switching between the layers by use of one signal.

The stacked optical modulation element 101 provided for writing an image by means of the threshold shifting method is configured so as to be able to bring, in accordance with the voltage applied to the transparent electrode 105 and the transparent electrode 106, an arbitrary display layer or both of the display layers into a reflection state or both of the display layers into a transmission state, by means of making the operation threshold value for cholesteric liquid crystal in the display layer 107a different from the operation threshold value for cholesteric liquid crystal in the display layer 107b.

FIG. 27 shows a graph showing switching behavior of cholesteric liquid crystal in the display layers 107a and 107b. As shown in FIG. 27, both the cholesteric liquid crystals of the display layers 107a and 107b are changed from a selective reflection state of a planar texture or a transmission state of a focal conic texture to a transmission state of a focal conic texture when the voltage externally applied with an electric power source 117 is increased, and changed from the focal conic texture to a homeotropic texture when the voltage is further increased, and both the liquid crystals are changed to a planar texture when the applied voltage is released.

However, as can be seen from the graph shown in FIG. 27, the threshold voltage at which a texture change arises in the display layer 107a is shifted from the threshold voltage at which a texture change arises in the display layer 107b. Specifically, the threshold voltage at which the texture changes from the planar texture to the focal conic texture (this threshold voltage is called a “lower threshold value” in the present invention) corresponds to Vpfa of the display layer 107a and Vpfb of the display layer 107b. Thus, the threshold voltage required by the cholesteric liquid crystal of the display layer 107b becomes higher. Meanwhile, the threshold voltage at which the texture changes from the focal conic texture to the homeotropic texture (this threshold voltage is called an “upper threshold value” in the present invention) corresponds to Vfpa of the display layer 107a and Vfpb of the display layer 107b. Thus, the threshold voltage required by the cholesteric liquid crystal of the display layer 107b becomes higher.

The threshold shifting method is for independently controlling the display layer 107a and the display layer 107b by utilization of a difference between the threshold values.

More specifically, a voltage for a period Vc which is lower than the upper threshold value Vfpb of the display layer 107b and higher than the upper threshold value Vfpa of the display layer 107a or a voltage for a period Vd which is higher than the upper threshold value Vfpb of the display layer 107b is selectively applied by means of the power supply 117. An area in the display layer 107b where the voltage for the period Vc is applied becomes a focal conic texture, and an area in the display layer 107a becomes a homeotropic texture. Meanwhile, an area in the display layer 107a where the voltage for the period Vd is applied remains in the homeotropic texture as in the case of the voltage for the period Vc. However, in the display layer 107b, the voltage exceeds the upper threshold voltage Vpfb, and hence the texture of the area where the voltage has been applied changes to the homeotropic texture.

Specifically, as a result of the voltage applied by the power supply 117 being set for the period Vc or the period Vd, the texture of the display layer 107b is selected to be a focal conic texture or a homeotropic texture. When the applied voltage is rapidly stopped in this state, the homeotropic texture changes to the planar texture, and the focal conic texture maintains its state. Meanwhile, before stoppage of application of the voltage, the display layer 107a remains in the homeotropic texture regardless of the voltage applied to the display layer. As a result of rapid stoppage of application of the voltage, all of the display layers change to the planar texture.

Subsequently, a voltage for the period Va which is lower than the lower threshold value Vpfa of the display layer 107a or a voltage for the period Vb which is higher than the lower threshold value Vpfa of the display layer 107a and lower than the lower threshold value Vfpb of the display layer 107b is selectively applied by means of the power supply 117. A voltage achieved in an area of the display layer 107a, where the voltage for the Vb period has been applied, exceeds the lower threshold value Vpfa, and the texture of the area changes to the focal conic texture. A voltage achieved in an area of the display layer 107b, where the voltage for the period Va has been applied, does not exceed the lower threshold value Vpfa, and the area remains in the planar texture. Meanwhile, a voltage achieved in the display layer 107b is lower than the lower threshold voltage Vfpb regardless of an applied voltage. As mentioned above, the display layer 107b maintains the planar texture or the focal conic texture selected by means of the upper threshold value.

As mentioned above, a texture is selected for each of the areas of the display layer 107a, and an image is written.

Specifically, an arbitrary display layer or both of the display layer 107a and the display layer 107b can be brought into a reflection state, or both of the display layer 107a and the display layer 107b can be brought into a transmission state. A reflection image can be displayed from a display side. Two display layers can be independently controlled by means of one drive signal. Hence, the structure of a medium is simplified, thereby reducing manufacturing cost.

One driving mode based on the threshold shifting method is a method for enabling switching of optical writing operation through use of a configuration including a photoconductive layer in the stacked optical modulation element. FIG. 28 is a schematic explanatory view for describing a manner of writing an image on a stacked optical modulation element including a photoconductive layer by means of a threshold shifting method. Like a stacked optical modulation element shown 111 in FIG. 28 and the stacked optical modulation element 101 shown in FIG. 24, two display layers 107a and 107b are stacked between a transparent electrode pair consisting of the transparent electrodes 105 and 106; and a photoconductor layer 110 is stacked between the display layer 107b and the transparent electrode 106. A coloring layer 109 is interposed between the photoconductor layer 110 and the display layer 107b.

In the present example, while the power supply 117 first applies a bias voltage by means of which the voltage (a reset voltage) for the period Vc being lower than the upper threshold value Vfpb of the display layer 107b and higher than the upper threshold value Vfpa of the display layer 107b are applied over the entire display layer, an exposure apparatus 112 selectively performs exposure to thus change (lower) the resistance value of the photoconductive layer 110 in an exposed area. Thus, a divided potential of the display layer 107a and that of the display layer 107b are increased. As a result, in the exposed area, the voltage applied to the display layer 107a and that applied to the display layer 107b exceed the upper threshold value Vpfb. Specifically, the exposure section is applied with the voltage for the period Vd. As a matter of course, non-exposed areas remain at the voltage for the period Vc. Consequently, selection of a texture change in liquid crystal, which is analogous to that achieved by means of performing selective switching at a voltage of the magnitude described by reference to FIG. 24, can be implemented by means of activation or deactivation of the exposure apparatus.

The switching principle also applies to the lower threshold value. Specifically, while the power supply 117 has applied, in advance, a bias voltage by means of which a voltage applied over the entire display layer becomes the voltage for the period Va that is lower than the lower threshold value Vpfa of the display layer 107a, to thus effect selective exposure. As a result, there can be selected change of the texture of liquid crystal between areas where the bias voltage exceeds the lower threshold value Vpfa and areas where the bias voltage does not exceed the lower threshold value Vpfa.

Namely, when the stacked optical modulation element including a photoconductive layer is driven by means of the threshold shifting method, exposure can be selectively performed while a predetermined voltage is applied for both the upper and lower threshold values and the thus-applied voltage is maintained, whereby writing can be implemented.

In order to enhance the operation margin for driving the plural display layers independently by using the threshold value shifting method (which is, in short, the distances in voltage of the upper and lower threshold values between the display layers, i.e., the widths of the ranges Vb and Vc in FIG. 27), it is generally considered to increase the ratio of the operation threshold value and the electric field between the display layers, or to increase the ratio of the electric fields applied to the display layers, which are determined by the dielectric constant and the thickness of the display layer.

However, in relation to cholesteric liquid crystal, a correlation generally exists between a relative dielectric constant and refractive-index anisotropy Δn and between the refractive anisotropy Δn and reflectivity. When a great dielectric ratio among the display layers has been set, brightness of a display layer of low dielectric constant is hardly acquired. In connection with cholesteric liquid material, the threshold field tends to become smaller with an increased dielectric constant, reversal of a relationship between the electric field applied to each of the display layers and the threshold field of each of the display layers is likely to arise, and difficulty is encountered in increasing the operation margin.

Incidentally, in the reflective liquid crystal display, contrast between selective reflection realized by the planar texture and selective transmission realized by the focal conic texture is extremely important for forming a clear display image. In the planar texture, achievement of the highest possible reflectance is desired. In the focal conic texture, the reflectance is desired to approach zero as closely as possible.

In some liquid crystal materials, there is a case where high reflectance can be acquired by application of a high-frequency pulse during writing operation, under the influence of moisture content, ions, and the like. However, in the case of an optical-writing reflective liquid crystal display in which liquid crystal layers (selective reflection layers) and OPC layers (organic photoconductive layers) are stacked one on top of the other, when a high-frequency pulse is applied for writing operation, a potential division ratio between the liquid crystal layer and the OPC layer is not relaxed to resistive potential division. There is a case where difficulty is encountered in acquiring a sufficient contrast ratio.

### SUMMARY

According to one aspect of the present invention, there is provided a method for driving a reflective liquid crystal display to record an image on the reflective liquid crystal display, the reflective liquid crystal display comprising: a pair of electrodes; and a selective reflection layer sandwiched between the pair of electrodes, the selective reflection layer including a cholesteric liquid crystal and selectively reflecting light of a wavelength,

the method comprising:

selectively applying two or more kinds of voltages, which includes a voltage V1_{H} exceeding an operation threshold value of the selective reflection layer and a voltage V1_{L} not exceeding the operation threshold value of the selective reflection layer, to the selective reflection layer for a period of time T_{V1}, so as to select, in the selective reflection layer, an area where the operation threshold value is exceeded and other area where the operation threshold value is not exceeded; and

applying a voltage V2 to the selective reflection layer, the voltage V2 having a frequency differing from that of the voltages V1_{H} and V1_{L}.

### BRIEF DESCRIPTION OF THE DRAWINGS

Embodiments of the present invention will be described in detail based on the following figures, wherein:

FIG. 1 is a graph showing a relationship between the magnitude of an adjustment voltage in a display layer (a selective reflection layer) which is comparatively susceptible to the influence of adjustment voltage-applying operation and reflectance of the display layer having undergone the adjustment voltage-applying operation;

FIG. 2 is a graph showing a relationship between the magnitude of an adjustment voltage in a display layer (a selective reflection layer) which is comparatively, less susceptible to the influence of adjustment voltage-applying operation and reflectance of the display layer having undergone the adjustment voltage-applying operation;

FIG. 3 is a schematic block diagram of a first embodiment which is an illustrative embodiment of a system to which is applied a method for driving a reflective liquid crystal display corresponding to an aspect (A) of the present invention;

FIG. 4 is a graph showing the switching behavior of cholesteric liquid crystal of each of the display layers in the reflective liquid crystal display used in the aspect (A);

FIG. 5 is a circuit diagram showing a circuit equivalent to a stacked display layer in the reflective liquid crystal display used in the aspect (A);

FIG. 6 is a graph for describing the ability to enlarge a potential division ratio by means of applying a voltage pulse of low frequency and to relax a capacitive division ratio to a resistive division ratio;

FIG. 7 is a graph showing a relationship between an applied voltage and a time, which represents fluctuations in a waveform induced by a residual potential after application of a final pulse when a voltage pulse of low frequency;

FIG. 8 is a graph showing a relationship between the magnitude of an adjustment voltage achieved when adjustment voltage-applying operation is performed in connection with a display layer (a selective reflection layer) of a certain liquid crystal configuration and reflectance of the display layer;

FIG. 9 is a graph showing a relationship between the magnitude of an adjustment voltage achieved when adjustment voltage appellation operation is performed in connection with a display layer (a selective reflection layer) of certain liquid crystal configuration and reflectance of the display layer, wherein a liquid crystal composition of the display layer shown in FIG. 8 and a liquid crystal display composition of a display layer shown in FIG. 10 are blended at a fifty-fifty proportion;

FIG. 10 is a graph showing a relationship between the magnitude of an adjustment voltage acquired when a display layer (a selective reflection layer) differing in liquid crystal configuration from the display layer shown in FIG. 8 is subjected to adjustment voltage-applying operation and reflectance of the display layer having undergone the adjustment voltage-applying operation;

FIG. 11 is a chart showing, in time series, the waveform of a voltage applied from a writing operation to an adjustment voltage-applying operation in the first embodiment;

FIG. 12 is a graph where there is plotted a relationship, which is a result of verification of the first embodiment, between the magnitude of an adjustment voltage in a display layer comparatively susceptible to the influence of adjustment voltage-applying operation and reflectance Y of an obtained display image;

FIG. 13 is a graph where there is plotted a relationship, which is a result of verification of the first embodiment, between the magnitude of an adjustment voltage in a display layer comparatively less susceptible to the influence of adjustment voltage-applying operation and reflectance Y of an obtained display image;

FIG. 14 is a graph showing the switching behavior of cholesteric liquid crystal of each of the display layers in the display medium of the first embodiment;

FIG. 15 is a graph showing an optical characteristic acquired when the respective display layers of the reflective liquid crystal display fabricated in the first embodiment are connected in series and a 5 Hz pulse voltage is applied to the display layers;

FIG. 16 is a graph showing optical characteristics achieved when the frequency of a pulse voltage is set to 50 Hz, as in the case of the graph shown in FIG. 15;

FIG. 17 is a graph showing a reflection spectrum of one display layer in the reflective liquid crystal display fabricated in the first embodiment;

FIG. 18 is a graph showing a reflection spectrum of another display layer of the reflective liquid crystal display fabricated in the first embodiment;

FIG. 19 is a schematic block diagram of a second embodiment which is another illustrative embodiment of a system to which is applied a method for driving a reflective liquid crystal display corresponding to the aspect (A);

FIG. 20 is a schematic block diagram of a third embodiment which is an illustrative embodiment of a system to which is applied a method for driving a reflective liquid crystal display corresponding to an aspect (B) of the present invention;

FIG. 21 is a chart showing, in time series, the waveform of a voltage applied from a writing operation to an adjustment voltage-applying operation in the third embodiment;

FIG. 22 is a graph showing a relationship between the value of an adjustment voltage and a reflectance value Y in the adjustment voltage-applying operation of the third embodiment;

FIG. 23 is a graph showing the switching behavior of cholesteric liquid crystal of each of the display layers in the stacked reflective liquid crystal display of three-layer configuration used for the threshold shift method;

FIG. 24 is a diagrammatic cross-sectional view for describing the way to write an image under the threshold shift method;

FIGS. 25A-25C are schematic descriptive views showing a relationship between a molecular orientation of cholesteric liquid crystal and an optical characteristic, wherein FIG. 25A shows a planar texture, FIG. 25B shows a focal conic texture, and FIG. 25C shows a homeotropic texture;

FIG. 26 is a graph for describing switching behavior of cholesteric liquid crystal;

FIG. 27 is a graph showing switching behavior of cholesteric liquid crystal of each of display layers in the stacked optical modulation element employed for the threshold shift method; and

FIG. 28 is a diagrammatic descriptive view for describing the way to write an image in the stacked optical modulation element including photoconductive layers, under the threshold shift method.

### DETAILED DESCRIPTION

As will be described later, an aspect of the present invention enables various reflectance control operations appropriate for the composition of liquid crystal, by means of operation (often merely called “adjustment voltage application operation”) which is immediately subsequent to voltage application for writing purpose and is performed in the adjustment voltage application step of applying a voltage (hereinafter sometimes called an “adjustment voltage”)—differing in frequency from the applied voltage for writing purpose—to the selective reflection layer.

As exemplary aspects of the present invention, aspects (A) and (B), which are provided below as specific, effective examples of utilization of the adjustment voltage-applying operation, are now mentioned. (A) denotes an aspect of the present invention in relation to adjustment voltage-applying operation being applied to the method for driving the stacked reflective liquid crystal display by means of the threshold shifting method; and (B) denotes an aspect of the present invention in relation to adjustment voltage-applying operation being applied for the purpose of enhancing brightness contrast of a single-layer optical writing reflective liquid crystal display.

### (A) An aspect of the present invention in relation to the adjustment voltage-applying operation being applied to the stacked reflective liquid crystal display by means of the threshold shifting method

According to the aspect (A), a reflective liquid crystal display including a plurality of selective reflection layers stacked without insertion of electrodes between the layers is taken as an object on which an image is recorded, the respective selective reflection layers selectively reflecting light of different wavelengths in the visible light region and differing from one another in terms of a lower threshold value serving as an operation threshold value for a voltage externally applied to induce a change from a planar texture to a focal conic texture and a higher threshold value serving as an operation threshold value for a voltage externally applied to induce a change from the focal conic texture to a homeotropic texture.

The operation threshold value employed in the writing operation (a first writing operation) is an upper threshold value for any of the selective reflection layers, and in the writing operation, two or more kinds of voltages including the voltage V1_{H} and the voltage V1_{L} is applied to the respective selective reflection layers to thus select, in each of the selective reflection layers, an area where the upper threshold value is exceeded or other area where the upper threshold value is not exceeded.

The driving method of the aspect further comprises a second writing operation, in succession to the adjustment voltage-applying operation, of applying two or more kinds of voltages (hereinafter sometimes called simply a “write voltage”), including a voltage V3_{H} exceeding the lower threshold value of any selective reflection layer other than the selective reflection layer selected in the writing operation as having the upper threshold value and a voltage V3_{L} not exceeding the lower threshold value, to each of the selective reflection layers, thereby selecting, in each of the selective reflection layers, an area where the lower threshold value is exceeded or other area where the lower threshold value is not exceeded.

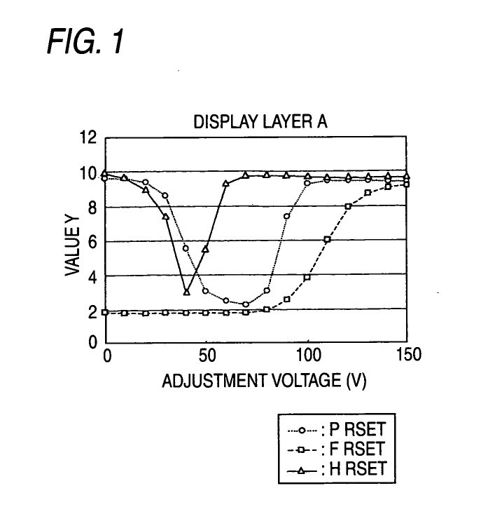

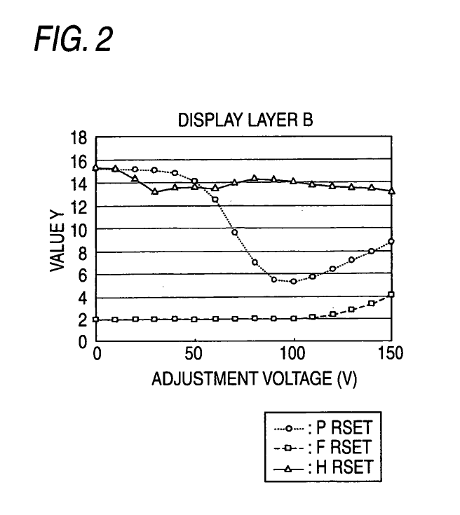

FIGS. 1 and 2 are example graphs showing a relationship between the magnitudes of adjustment voltages achieved in two display layers (selective reflection layers) affected differently by adjustment voltage-applying operation and the reflectance of the display layers having undergone the adjustment voltage-applying operation. FIG. 1 is a graph pertaining to the display layer A which is comparatively susceptible to the influence of adjustment voltage-applying operation. FIG. 2 is a graph pertaining to the display layer B which is comparatively less susceptible to the influence of adjustment voltage-applying operation.

FIGS. 1 and 2 are graphs plotting relationships between final luminous reflectance Y and magnitudes of adjustment voltages. Specifically, the relationships are acquired by means of having aligned all of the areas of display layers to a planar texture in advance; applying voltages to the display layers in a writing operation to thus bring the display layers into a texture state; and immediately subsequently subjecting the display layers to application of adjustment voltages, to thus acquire final luminous reflectance Y. The vertical axis represents luminous reflectance Y of the respective display layers, and the horizontal axis represents pulse voltages applied as adjustment voltages.

FIGS. 1 and 2 are graphs showing a “P reset” (a planar reset), an “F” reset” (a focal conic reset), and an “H” reset (a homeotropic reset). The term “P reset” means that adjustment voltage-applying operation is performed while the respective display layers remain in the planar texture in the writing operation. The term “F reset” means that adjustment voltage-applying operation is performed after a voltage—which exceeds the lower threshold value of the respective display layer and does not exceed the upper threshold value of the same—has been applied in the writing operation to each of the display layers to thereby bring liquid crystal into the focal conic texture. The term “H reset” means that a voltage—which exceeds the upper threshold value of the respective display layer—is applied in the writing operation to thus bring liquid crystal into a homeotropic texture, and that adjustment voltage-applying operation is performed continually. In the following descriptions, the same applies to the interpretation of the terms “planer (P) reset,” “focal (F) conic reset,” and “homeotropic (H) reset.”

As is evident from FIGS. 1 and 2, the influence of adjustment voltage-applying operation to reflectance of the display layer A greatly differs from the influence on the reflectance of the display layer B.

When the F reset and the H reset in both graphs are viewed in more detail, no major changes are found in the reflectance at the F reset and the H reset in connection with the display layer B. However, the reflectance of the display layer A at the F reset is found to increase from the neighborhood of a point where the adjustment voltage has exceeded 80V, and the luminous reflectance Y approaches 10 in the neighborhood of a point where the adjustment voltage is 130 V, and the display layer is understood to be in a selective reflection state (i.e., the planer texture). However, in relation to the H reset, major changes are not found in the luminous reflectance Y when the adjustment voltage is 80 V or higher.

This aspect of the present invention is intended for ensuring an operation margin at the upper threshold value by means of utilizing a difference between characteristics of changes in the reflectance of the display layers A and B with respect to the adjustment voltage.

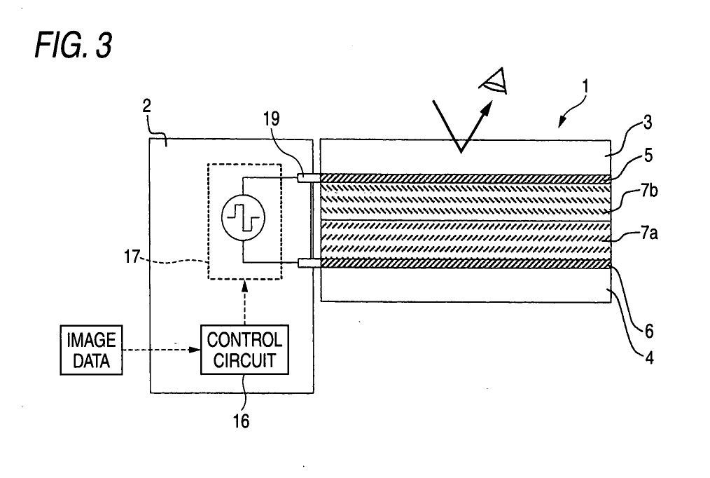

FIG. 3 is a schematic block diagram showing an illustrative mode of a system to which is applied the reflective liquid crystal display-driving method corresponding to this aspect of the present invention; namely, a first embodiment to be described later. A system shown in FIG. 3 comprises a display medium (a reflective liquid crystal display) 1 and a writing device (a drive device for a reflective liquid crystal display) 2. These constituent elements and detailed operations thereof will be described later, and there will be merely provided general descriptions about operations and advantages of the applied invention.

In the embodiment shown in FIG. 3, the display medium 1 is a stacked reflective liquid crystal display formed by means of stacking, in sequence from a display screen side, a transparent substrate 3; a transparent electrode 5; a display layer (a selective reflection layer) 7b; a display layer (a selective reflection layer) 7a; a transparent electrode (electrode) 6; and a transparent substrate 4. In relation to this display medium 1, it is assumed that the display layer A having characteristics represented by the graph of FIG. 1 is formed as the display layer 7a and that the display layer B having characteristics represented by the graph of FIG. 2 is formed as the display layer 7b.

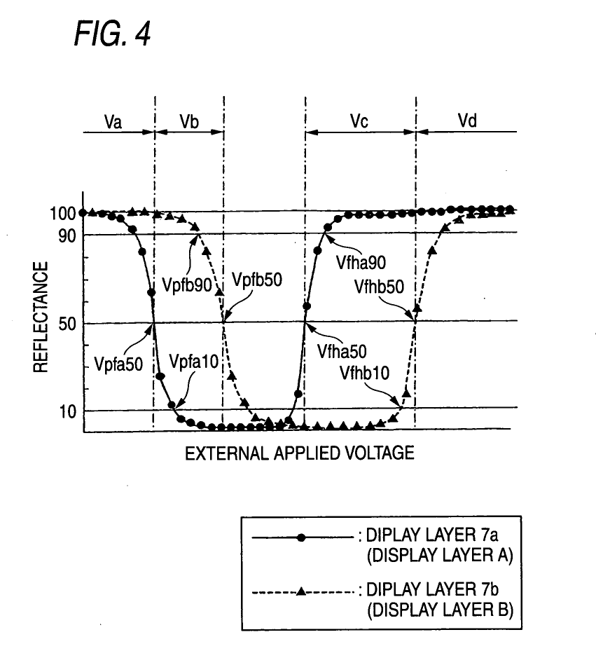

FIG. 4 shows, in the form of graphs, switching behaviors of cholesteric liquid crystal in the respective display layers 7a, 7b (A, B) in the display medium (a reflective liquid crystal display) 1 shown in FIG. 3. Descriptions are provided by reference to the graphs in FIG. 4, and an operation margin Vm of each of the display layers (the selective reflection layers) achieved when a voltage is applied to the reflective liquid crystal display of two-layer configuration can be expressed as follows.

A voltage—at which normalization reflectance of each of the display layers assumes a value of 90% when each of the display layers shifts from the planar texture to the focal conic texture (at the lower threshold value)—is taken as Vpf 90. A voltage at which normalization reflection assumes a value of 50% is taken as Vpf 50. A voltage at which normalization reflection assumes a value of 10% is taken as Vpf 10. A prefix “b” affixed to numerals denotes the display layer “b” requiring high upper and lower threshold voltages. Similarly, a prefix “a” affixed to numerals denotes the display layer “a” requiring lower upper and lower threshold voltages. An operation margin Vm achieved at the lower threshold value can be expressed as Vm=2×(Vpfb90−Vpfa10)/(Vpfb50+Vpfa50).

The operation margin is desirably a positive value.

Likewise, a voltage—at which normalization reflectance of each of the display layers assumes a value of 90% when each of the display layers (selective reflection layers) shifts from the focal conic texture to the homeotropic texture (at the upper threshold value)—is taken as Vfh 90. A voltage at which normalization reflection assumes a value of 50% is taken as Vfh 50. A voltage at which normalization reflection assumes a value of 10% is taken as Vfh 10. In the same manner as mentioned previously, prefixes “a” and “b” are affixed to numerals. In that case, an operation margin Vm achieved at the upper threshold value can be expressed as Vm=2×(Vfhb10−Vfha90)/(Vfhb50+Vfha50).

When difficulty is encountered in sufficiently assuring the operation margin Vm at the upper threshold value, the adjustment voltage-applying operation of the present invention can be utilized.

First, in the writing operation, a voltage application section 17 performs selective application of either the voltage for the period Vc that is lower than the upper threshold value Vfhb of the display layer 7b but higher than the upper threshold value Vfha of the display layer 7a or the voltage for the period Vd that is higher than the upper threshold value Vfhb of the display layer 7b. When the operation margin Vm is sufficiently ensured at the upper threshold value, areas of the display layer 7b applied with the voltage for the period Vc enter a focal conic texture, and areas of the display layer 7a applied with the same enter a homeotropic texture. Meanwhile, areas of the display layer 7a applied with the voltage for the period Vd enter a homeotropic texture as in the case of the voltage for the period Vc. However, a voltage achieved in areas of the display layer 7b applied with the voltage for the period Vd exceeds the upper threshold value Vfhb, and hence the areas enter the homeotropic texture.

In short, by means of determining whether the voltage for the period Vc or the voltage for the period Vd is selected as the voltage applied by the voltage application section 17, either the focal conic texture or the homeotropic texture is selected as the texture of the display layer 7b. When the applied voltage is rapidly stopped in this state, the homeotropic texture changes to the planar texture, and the focal conic texture is maintained. Meanwhile, the display layer 7a is in the homeotropic texture before stoppage of application of a voltage, regardless of whether the applied voltage is the voltage for the period Vc or the voltage for the period Vd. All of the display layers change to the planar texture as a result of rapid stoppage of application of a voltage.

However, in a case where the operation margin Vm is not sufficiently ensured at the upper threshold value, it is assumed that, when a voltage is applied to the display layer 7b so as to definitely select either the focal conic texture or the homeotropic texture for the display layer 7b, the texture of portions of the display layer 7a remain in the focal conic texture and do not change. Under the threshold shifting method, if a layer whose texture is desired to be selected at the upper threshold value is the display layer 7b, all areas of the other display layer 7a are desired to be aligned to the homeotropic texture in this writing operation.

Accordingly, in the present applied invention, operation pertaining to the adjustment voltage-applying operation is performed continually subsequent to the writing operation.

In the adjustment voltage-applying operation, a voltage which differs in frequency from the voltage applied in the writing operation; namely, an adjustment voltage, is applied. When a divided voltage applied to the display layer 7a at this time is assumed to be, e.g., 130V, the areas (areas in the H-reset state) of homeotropic texture in the display layer 7a maintain the homeotropic state intact. The texture of the areas of focal conic texture (areas in the F-reset state) changes to the homeotropic texture. All of the areas finally enter the homeotropic texture. As indicated by the graph shown in FIG. 1, the texture of the display layers changes to the planar texture simultaneous with stoppage of application of a voltage, whereupon the display layer enters a reflection state.

As can be seen from the graphs of FIG. 2, the texture of the display layer 7b is not affected by an adjustment voltage of 130V or less. All of the areas where the homeotropic texture is selected (areas in the H-reset state) and all of the areas where the focal conic texture is selected (areas in the F-reset state) maintain the textures achieved before being applied with the adjustment voltage. Upon stoppage of an applied voltage, only the areas of homeotropic texture change to the planer texture, so that an image is formed by means of selective reflection of the planar texture and selective transmission of the focal conic texture.

As has been described above, even when difficulty is encountered in ensuring operation margin at the upper threshold value for reasons of the composition of liquid crystal, ensuring of intended performance, or the like, application of an adjustment voltage-applying operation featuring the present invention can yield an advantage that is the same as that yielded when substantially wide operation margin is ensured. Therefore, the freedom degree of design and selection of a liquid crystal configuration is improved. For instance, even at the time of the operation margin being ensured at the lower threshold value to be described later, limitations are reduced. Thus, a high operation margin can be ensured as a whole. Stable threshold shift driving can be implemented while each of the display layers (the selective reflection layers) of the stacked reflective liquid crystal display is provided with sufficient reflectance.

As mentioned above, an essentially-wide operation margin can be ensured at the upper threshold value by utilization of the adjustment voltage-applying operation featuring the present invention. In order to sufficiently ensure operation margin for the lower threshold value, the frequency (F_{V3}) of second write voltages (V3_{H} and V3_{L}) applied during the second writing operation may be made lower (F_{V3}<F_{V1}) than the frequency (F_{V1}) of the write voltages (V1_{H} and V1_{L}) applied during the writing operation. The reason for this will now be described.

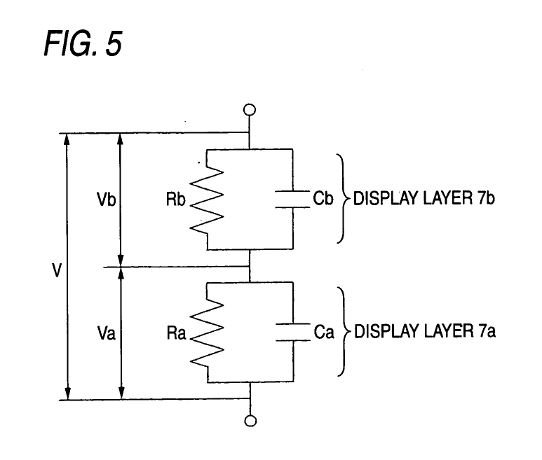

FIG. 5 is a circuit diagram showing a circuit equivalent to the display layers 7a, 7b of stacked state in the stacked reflective liquid crystal display (the display medium 1) shown in FIG. 3. Reference symbol Ca designates static capacitance equivalent to the static capacitance of the display layer 7a requiring low upper and lower threshold voltages; and Ra designates resistance equivalent to the resistance of the same. Reference symbol Cb designates static capacitance equivalent to the static capacitance of the display layer 7b having the high upper and lower threshold voltages; and Rb designates resistance equivalent to that of the display layer 7b having the same.

In order to increase the ratio of the electric field applied to the display layer 7a to that applied to the display layer 7b, a conceivable method is to ensure a wide ratio of the dielectric constant of the display layer 7a to the dielectric constant of the display layer 7b and to increase a capacitive division ratio. However, as mentioned previously, a positive correlation generally exists between the specific inductive capacity of cholesteric liquid crystal and refractive anisotropy Δn. Hence, under the above-mentioned method, a bright display is hardly achieved by the display layer of low dielectric constant (the display layer 7a in this case). When the dielectric constant of a liquid crystal material increases, the threshold electric field tends to become lower. Hence, the threshold electric field of the display layer of high dielectric constant (the display layer 7b in this case) having a small capacitive division ratio becomes smaller, which in turn poses difficulty in enlarging the operation margin.

A change in orientation arising from the planar texture to the focal conic texture at the lower threshold value is considered to be caused by accumulation of field energy exerted on the display layer including cholesteric liquid crystal. The present inventors have found that the drawbacks mentioned above are solved by making the specific resistance values of the respective liquid crystal materials different from each other and applying a voltage pulse of such a low frequency as to relax the potential division ratio between the display layers from a capacitive division ratio to a resistive division ratio (a ratio of dependence on the resistive division ratio is increased).

Specifically, potential division is performed by utilization of a resistive division ratio between the display layers, thereby obviating a necessity to ensure a large dielectric ratio between liquid crystal materials of the display layers. Accordingly, a liquid crystal material having high refractive anisotropy Δn can be used for each of the display layers, so that a bright display can be obtained. Reversal of threshold field becomes unlikely to arise as a result of a reduction in the dielectric ratio, and hence operation margin can be readily enlarged. The waveform of an applied pulse may be a square wave. However, an ascending triangular wave, a sinewave, or a d.c. pulse, which is more susceptible to a resistance component, is desirable.

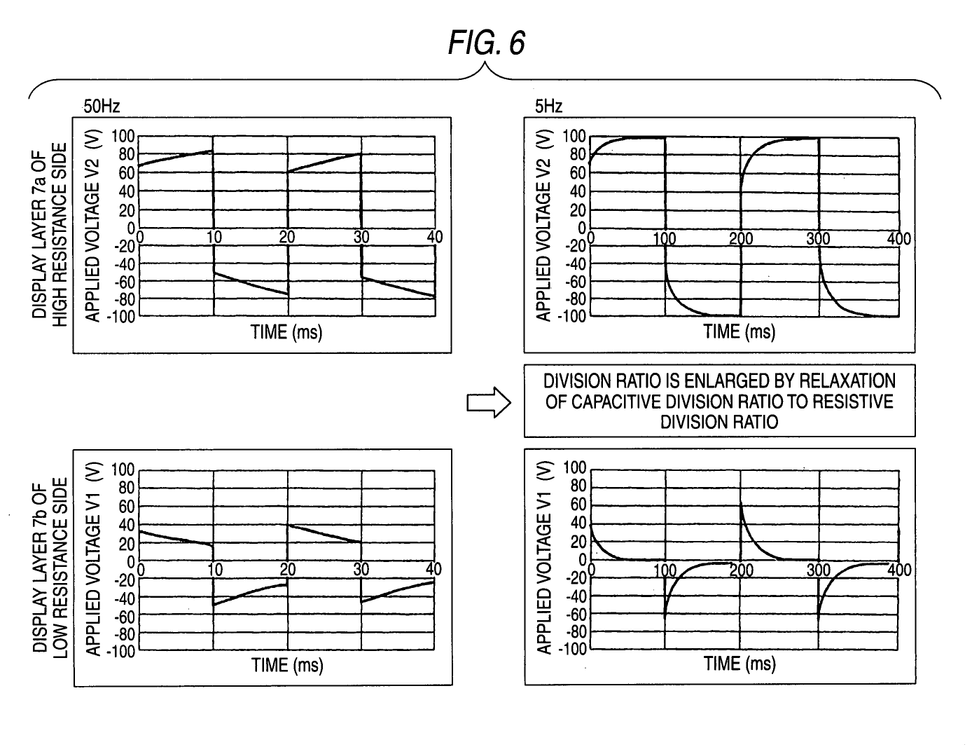

FIG. 6 shows graphs for describing the ability to attain relaxation of the capacitive division ratio to the resistive division ratio and enlargement of the division ratio by means of application of a voltage pulse of low frequency. In FIG. 6, the two upper graphs show the transition of a divided potential Va for the display layer 7a of high resistance, and the two lower graphs show the transition of a divided potential Vb for the display layer 7b of low resistance. In each of the upper and lower graphs, the left graph pertains to application of a pulse wave of 50 Hz, and right graph pertains to application of a pulse wave of 5 Hz. In the graphs, the length between calibration markings per unit time on the horizontal axis for a frequency of 50 Hz is ten times the length between calibration markings per unit time on the horizontal axis for a frequency of 5 Hz.

In order to implement the present invention, resistance of each of the layers is also adjusted (namely, the liquid crystal material of each layer is selected such that the display layer 7a exhibits high resistance and such that the display layer 7b exhibits low resistance).

When a pulse wave having a frequency of 50 Hz is applied to the display layers, the voltage applied in the form of a pulse wave tends to increase or decrease with lapse of time but to transition linearly, as represented by the left-side graph of each of the upper and lower rows. In contrast, when the pulse wave having a frequency of 5 Hz is applied to the display layers, the voltage applied in the form of a pulse waveform continually exhibits the tendency to increase or decrease with lapse of time until the tendency becomes constant, as represented by the right-side graph of each of the upper and lower rows. Consequently, a potential division ratio between the display layer 7a and the display layer 7b is understood to have been widened.

Specifically, the time constant of relaxation of the capacitive division ratio of the voltage applied to the respective display layers to the resistive division ratio is reduced with regard to the operation margin of the lower threshold value, and a pulse having such a frequency and a waveform as to increase the influence of a resistance component is added. Limitations on the dielectric constant are diminished by means of utilization of the resistance ratio between the respective layers, thereby enhancing the freedom degree of design of the liquid crystal material.

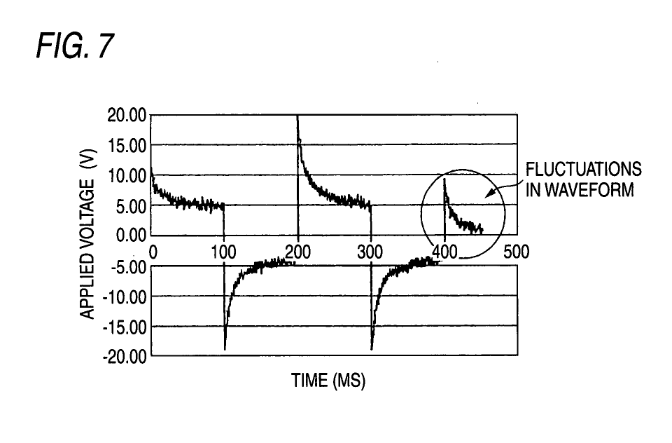

However, upon application of the voltage pulse of a waveform (a low frequency) utilizing relaxation of a capacitive element into a resistive element, a disturbance arises in a waveform for reasons of a residual potential after application of a final pulse. FIG. 7 is a graph showing a relationship between an applied voltage and time, which represents a disturbance in the waveform. Even after application of a voltage (400 ms in the graph), a pulse having a distorted waveform is applied under the influence of a residual potential. When a low-frequency voltage is applied, the disturbance cannot be completely avoided. For reasons of the disturbance in the waveform acquired after application of the final pulse, a change in orientation from the homeotropic texture to the planar texture is hindered, thereby deteriorating reflectance. Therefore, interference arises in switching operation performed at the higher threshold value.

The frequency of a voltage to be applied is changed by means of the writing operation performed at the upper threshold value and the writing operation performed at the lower threshold value, thereby solving the drawbacks. In the above example, the frequency of an applied voltage is lowered in order to ensure the operation margin at the lower threshold value, thereby relaxing the capacitive division ratio to the resistive division ratio. Further, the frequency is increased with regard to the switching operation performed at the upper threshold value susceptible to the disturbance that arises in the waveform for reasons of the low-frequency voltage, thereby realizing stable operation and ensuring operation margin.

The related-art waveform utilizing capacitive division; namely, a high-frequency voltage, may be applied in connection with the upper threshold value. In connection with the lower threshold value, a waveform utilizing resistive division; namely, a low-frequency voltage, is applied. As mentioned above, voltages of different frequencies (or waveforms) are applied as a voltage (a reset voltage) applied at the upper threshold value and a voltage (a select voltage) applied at the lower threshold value. Thus, a reflective liquid crystal display can be driven while display layers of high reflectance are realized and an operation margin at the lower threshold value is ensured. Thus, the practical utility of driving of the reflective liquid crystal display based on the threshold shifting method is enhanced to a much greater extent.

In relation to the frequency of an applied voltage which is to be changed between the writing operation and the second writing operation, a frequency F_{V3} of the applied voltage V3 employed in the second writing operation (at the time of lower threshold switching) is preferably set so as to fall within a range of 0 to 100 Hz; more preferably a range of 0 to 30 Hz. When the frequency F_{V3} exceeds 100 Hz, relaxation of the capacitive division ratio to the resistive division ratio becomes insufficient, thereby leading to a case where difficulty is encountered in ensuring operation margin. Thus, a frequency of 100 Hz or more is not preferable.

Under a reflective liquid crystal display-driving method according to one aspect of the present invention, the selective reflection layer may be of a minimum of two-layer configuration or a three-layer configuration which enables formation of a full-color image.

The aspect (A) of the present invention can also be applied even when the reflective liquid crystal display to which an image is recorded is an optical-writing substance having a structure including a photoconductive layer. Specifically, the reflective liquid crystal display-driving method of the applied invention having a configuration including a photoconductive layer comprises the configuration of the aspect (A) of the present invention.

Further, an optical-writing reflective liquid crystal display is taken as an object on which an image is recorded, a photoconductive layer being stacked on one surface of the plurality of stacked selective reflection layers, and the selective reflection layers with the photoconductive layer being sandwiched between the pair of electrodes.

The writing operation (first writing operation) is performed by selectively exposing to an address light, as required, while applying to the pair of electrodes the bias voltage V1 in which the bias voltage V1 is divided into the voltage V1_{H} applied to the selective reflection layer during exposure by the address light and the voltage V1_{L} applied to the selective reflection layer during non-exposure by the address light.

The second writing operation is performed by selectively exposing to an address light, as required, while applying to the pair of electrodes the bias voltage V3 in which the bias voltage V3 is divided into the voltage V3_{H} applied to the selective reflection layer during exposure by the address light and the voltage V3_{L} applied to the selective reflection layer during non-exposure by the address light.

In the optical-writing reflective liquid crystal display, bias voltages V1 to V3, by means of which a voltage V1_{L} or V3_{L} is applied to the selective reflection layers in a divided manner during non-exposure, is applied to the pair of electrodes in the writing operation and the second writing operation. During exposure by the address light, the voltage V1_{H} or V3_{H} is applied to the selective reflection layers. As a result, there can be achieved operation and advantages which are essentially the same as those achieved by the configuration for writing an image by means of only the magnitude of a write voltage. Thus, the operation and advantage of the present invention and those of the applied invention are yielded.

### (B) An aspect of the present invention in which the present invention is applied for the purpose of enhancing a contrast ratio of a single-layer, optical-writing, and reflective liquid crystal display

According to the aspect (A), an optical-writing reflective liquid crystal display is taken as an object on which an image is recorded, a photoconductive layer being stacked along with the selective reflection layer formed from only one layer, and the selective reflection layer with the photoconductive layer being sandwiched between the pair of electrodes.

The writing operation is performed by selectively exposing to an address light, as required, while applying to the pair of electrodes the bias voltage V1 in which the bias voltage V1 is divided into the voltage V1_{H} applied to the selective reflection layer during exposure by the address light and the voltage V1_{L} applied to the selective reflection layer during non-exposure, thereby selecting, in the selective reflection layer, an area where the threshold value is exceeded or other area where the threshold value is not exceeded.

An application time T_{V2} during which the voltage V2 is applied in the adjustment voltage-applying operation is shorter than an application time T_{V1} during which the voltage V1 is applied in the writing operation (T_{V1}>T_{V2}). At this time, the voltage V2 employed in the adjustment voltage-applying operation may be a half period component (a d.c. component) of one pulse.

As mentioned previously in connection with the related-art section, there is a case where, depending on a liquid crystal material, the reflective liquid crystal display provides a display image of high reflectance by application of a high-frequency pulse as a write voltage, under the influence of moisture or ion content. For instance, in an optical-writing reflective liquid crystal display into which a liquid crystal layer (a selective reflection layer) and an OPC layer (an organic photoconductive layer) are stacked, when a high-frequency pulse is applied for writing operation, the potential division ratio is not relaxed to the resistive division ratio between the liquid crystal layer and the OPC layer. Hence, there is a case where difficulty is encountered in achieving a sufficient contrast ratio.

In this aspect of the present invention, the writing operation is performed by means of applying a voltage of the same frequency as that employed in the related art. Subsequently, a short pulse voltage having a different frequency is applied in the adjustment voltage-applying operation. A period of time during which the pulse voltage is applied is considerably short and can be grasped as a half wavelength of a high-frequency rectangular pulse. Consequently, an advantage yielded when a high-frequency pulse is used for writing operation is acquired, and a display image of high reflectance is obtained.

General descriptions about a reflective liquid crystal display-driving method of the present invention and the aspects (A), (B) utilizing the method have thus been provided above. The reflective liquid crystal display-driving method of the present invention is intended for proposing a new reflectance control method that is separate from and independent of the driving operation for writing an image on the reflective liquid crystal display. Various reflectance control operations are enabled by means of combining the technique with the related-art known techniques. Specifically, applied embodiments of a reflective liquid crystal display-driving method of the present invention are not limited to the aspects (A) and (B) of the present invention. By means of adjusting the adjustment voltage-applying operation or other conditions, as appropriate, various reflectance control operations become feasible.

Under the reflective liquid crystal display-driving methods (including the aspects (A) and (B)) of the present invention, when the reflective liquid crystal display serving as an object on which an image is recorded is an optical-writing substance having a configuration including a photoconductive layer, the photoconductive layer may be formed from an organic photoconductor.

Moreover, under these reflective liquid crystal display-driving methods (including the aspects (A) and (B)) of the present invention, the one selective reflection layer or the two or more selective reflection layers can be formed by means of dispersing the cholesteric liquid crystal in a polymer.

Exemplary embodiments of the present invention will be described in detail hereinbelow by reference to the drawings.

### First Embodiment

A first embodiment is an exemplary embodiment of an aspect (A) in which the configuration of the present invention is applied to a method for driving a voltage-writing, stacked, reflective liquid crystal display by means of a threshold shift method.

As has been described, FIG. 3 is a schematic block diagram of the first embodiment showing an illustrative mode of a system to which the reflective liquid crystal display-driving method of the present invention is applied. The system of the present embodiment comprises a display medium (a reflective liquid crystal display) 1 and a writing device (a drive device for a reflective liquid crystal display) 2. These constituent elements will first be described in detail, and operations of the elements are subsequently described.

### <Display Medium>

The display medium 1 of the present embodiment is a member which enables selective driving of a plurality of liquid crystal layers (selective reflection layers) by application of a bias signal; specifically, a reflective liquid crystal display.

In the present embodiment, the display medium 1 is a subject formed by means of stacking, in sequence from a display surface side, a transparent substrate 3; a transparent electrode 5; a display layer (a selective reflection layer) 7b; a display layer (a selective reflection layer) 7a; a transparent electrode (electrode) 6; and a transparent substrate 4.

### (Transparent Substrate)

The transparent substrates 3, 4 are members intended for retaining respective functional layers on interior surfaces of the substrates, to thus maintain the structure of a display medium. The transparent substrates 3, 4 are sheet-shaped subjects having strength withstanding external force, and have at least the function of enabling transmission of incident light. The transparent substrates 3, 4 may possess flexibility. An inorganic sheet (e.g., glass, silicon), a polymeric film (e.g., polyethylene terephthalate, polysulfone, polyethersulfone, polycarbonate, polyethylene naphthalate), and the like, can be mentioned as a specific material for the transparent substrates 3, 4. A known functional film, such as an antifouling film, an abrasion resistant film, an anti-reflection film, a gas barrier film, and the like, may be formed on the exterior surface of the transparent substrate.

### (Transparent Electrode)

Transparent electrodes 5, 6 are members intended for uniformly applying a bias voltage applied by the writing apparatus 2 over the surface of each of the functional layers in an optical address element. The transparent electrodes 5, 6 have uniform conductivity over the surfaces thereof, and permit transmission of at least incident light and address light. Specifically, a conductive thin film formed from metal (e.g., gold, aluminum), a metallic oxide (e.g., an indium oxide, a tin oxide, an indium-tin oxide (ITO)), a conductive organic polymer (e.g., polythiophene-based conductive organic polymers and polyaniline-based conductive organic polymers), and the like, can be mentioned as the materials for the transparent electrodes. Known functional films, such as an adhesion improvement film, an anti-reflection film, a gas barrier film, and the like, may also be formed over the surface of the transparent electrodes. In the present invention, an electrode provided opposite the electrode on the display side (i.e., the transparent electrode 6 of the present embodiment) may also be nontransparent.

### (Display Layer)

The display layers of the present invention have the function of reflecting specific color light in incident light and modulating transmission state of the light by means of an electric field; and have a characteristic of enabling retaining a selected state in a field-free state. The display layer can have a structure which does not become deformed by external force, such as flexure or pressure.

In the present embodiment, a liquid crystal layer of a self-holding-type liquid crystal composite made from cholesteric liquid crystal and transparent resin is formed as the display layer. Specifically, the display layer is a liquid crystal layer which does not require a composite a spacer, or the like, for imparting a self-holding characteristic. Although not illustrated in the present embodiment, cholesteric liquid crystal remains dispersed in a polymeric matrix (transparent resin).

In the present invention, the display layer being a liquid crystal layer of a self-holding-type liquid crystal composite is not indispensable. The display layer may also be formed from only liquid crystal.

Cholesteric liquid crystal has the function of modulating the reflecting and transmitting state of specific color light of the incident light. Liquid crystal molecules are oriented in a helically-twisted manner. Of the light having entered in the helical axis, specific light dependent on a helical pitch is subjected to interference and reflection. By means of an electric field, the orientation and the reflecting state can be changed. When the display layer is formed into a self-retaining liquid crystal composite, a drop size may be uniform, and the composite may be arranged densely in a single layer.

Specific liquid crystal which can be used as cholesteric liquid crystal includes liquid crystals formed by means of adding an optically active material (e.g., steroid-based cholesterol derivatives, Schiff-base-based materials, azo-based materials, ester-based materials, biphenyl-based materials) to nematic liquid crystals, and smectic liquid crystals (e.g., Schiff-base-based liquid crystals, azo-based liquid crystals, azoxy-based liquid crystals, benzoic-ester-based liquid crystals, biphenyl-based liquid crystals, terphenyl-based liquid crystals, cyclohexyl-carboxylate-based liquid crystals, phenylcyclohexane-based liquid crystals, biphenylcyclohexane-based liquid crystals, pyrimidine-based liquid crystals, dioxane-based liquid crystals, cyclohexyl-cyclohexane-ester-based liquid crystals, cyclohexyl-ethane-based liquid crystals, cyclohexane-based liquid crystals, tolan-based liquid crystals, alkenyl-based liquid crystals, stilbene-based liquid crystals, multiply-fused-ring-based liquid crystals), or mixtures thereof; or the like.

The helical pitch of cholesteric liquid crystal is adjusted by means of the amount of chiral agent added to nematic liquid crystal. For instance, when blue, green, and red are taken as display colors, the center wavelengths of selective reflection fall within a range of 400 nm to 500 nm; a range of 500 nm to 600 nm; and a range of 600 nm to 700 nm, respectively. In order to compensate for temperature dependence of the helical pitch of cholesteric liquid crystal, there may also be used a known technique of addition of a plurality of chiral agents which twist in different directions or exhibit reverse temperature dependence characteristics.

In a mode where the display layers 7a, 7b form a self-holding liquid crystal composite made up of cholesteric liquid crystal and a macromolecular matrix (transparent resin), there can be used a PNLC (Polymer Network Liquid crystal) structure including mesh-shaped resin in a continuous texture of cholesteric liquid crystal or a PDLC (Polymer Dispersed Liquid crystal) structure where cholesteric liquid crystal is dispersed in the form of a droplet in a polymeric framework structure. By means of adoption of either the PNLC structure or the PDLC structure, an anchoring effect arises in an interface between cholesteric liquid crystal and polymer, and retention of the planar texture or the focal conic texture in a field-free state can be made more stable.

The PNLC structure and the PDLC structure can be formed according to a known method for subjecting polymer and liquid crystal to texture separation; for example, a PIPS (Polymerization Induced Texture Separation) method for mixing liquid crystal with polymeric precursors which effect polymerization by means of heat, light, electron beams, and the like; for example, acrylic precursors, thiol-based precursors, epoxy-based precursors and the like, and for polymerizing the mixture in a uniform texture and subjecting the thus-polymerized mixture to texture separation; an emulsion method for mixing liquid crystal with a polymer exhibiting low liquid crystal solubility, such as polyvinyl alcohol, agitating and suspending the mixture, and dispersing the liquid crystal in a polymer in the form of droplets; a TIPS (Thermally-Induced Texture Separation) method for mixing thermoplastic polymer with liquid crystal and cooling the mixture heated in a uniform texture to thus effect texture separation; and an SIPS (Solvent Induced Texture Separation) method for dissolving polymer and liquid crystal into a solvent such as chloroform and evaporating the solvent to thus subject the polymer to liquid crystal to texture separation. However, no limitations are imposed on the method for forming the PNLC structure and the PDLC structure.

The polymeric matrix has the function of retaining cholesteric liquid crystal and preventing the flow of liquid crystal (changes in an image), which would otherwise be caused by deformation of a display medium. A polymeric material—which is not dissolved in a liquid crystal material and uses, as a solvent, a liquid incompatible with liquid crystal—can be used. The polymeric matrix is desired to be a material which has strength withstanding external force and exhibits high transmissivity for at least reflected light and address light.

Materials which can be adopted as the polymeric matrix include a water-soluble polymeric material (e.g., gelatin, polyvinyl alcohol, a cellulose derivative, a polyacrylic polymer, ethyleneimine, a polyethylene oxide, polyacrylamide, polystyrenesulfonate, polyamidine, and an isoprene-based sulfonic polymer); a material which can be formed into an aqueous emulsion (e.g., a fluororesin, a silicone resin, an acrylic resin, a urethane resin, an epoxy resin); and the like.

In the display medium 1 serving as a reflective liquid crystal display used in the threshold shift method, the upper and lower threshold values are desired to be separated, as appropriate, from each other in each of the display layers 7a and 7b, to thereby ensure an operation margin for the threshold shift method. In the present invention, a capacitor ratio and a resistor ratio are suitably adjusted, by means of appropriately adjusting the thickness of a liquid crystal material and the thickness of each of the layers.

The specific resistance of the liquid crystal material can be controlled by means of, e.g., mixing a fluorine-based material of high resistance with a cyano-based material of low resistance or doping the liquid crystal material with ionic impurities. At this time, the respective display layers must be made slightly different from each other in terms of capacitance. The capacitive difference between the display layers can be controlled by means of making the liquid crystal materials different from each other in terms of a dielectric constant or making the display layers different from each other in terms of a thickness.

In addition, the switching behaviors of the display layers 7a, 7b can also be controlled by means of dielectric anisotropy, an elastic modulus, a helical pitch, a polymeric framework structure, and side chains of cholesteric liquid crystal forming the display layers 7a, 7b; a texture separation process; morphology of an interface between the polymeric matrix and the display layers 7a, 7b; the degree of anchoring effect achieved between the polymeric matrix and the display layers 7a, 7b, which is determined by all of these factors; and the like.

More specifically, the factors used for controlling the switching behaviors include the type and composition ratio of nematic liquid crystal; the type of a chiral agent; the type of a resin; the type and composition ratio of monomer and oligomer which are starting materials of a polymeric resin; the type and composition ratio of an initiator and a cross-linking agent; a polymerization temperature; the exposure light source, exposure intensity, an exposure time, and an ambient temperature for photopolymerization; electron intensity, an exposure time, and an ambient temperature for electronic polymerization; the types and composition ratio of solvents used for application; the concentration of a solution; the thickness of a wet film; a drying temperature; the starting temperature of a temperature drop; a temperature drop rate; and the like. However, the factors are not limited to these.

In order to control the influence of the liquid crystal composition on the adjustment voltage-applying operation unique to the present invention, appropriate adjustment of the above-described liquid crystal composition can be performed. However, behaviors in response to the adjustment voltage-applying operation vary according to a liquid crystal material. Therefore, the display layers are configured such that a desired effect is exhibited at the time of application of an adjustment voltage while a liquid crystal composition is being adjusted. For instance, specific objects of adjustment include selection of a liquid crystal material, the composition and viscosity of liquid crystal, adjustment of impedance, and the like.

As a matter of course, even when the composition of liquid crystal has been adjusted, the effects of adjustment of the composition are not necessarily exhibited in an optimal manner. Therefore, it is desirable to temporarily form, from a liquid crystal composition, a liquid crystal layer constituting a display layer; to verify characteristics of the liquid crystal layer; and to set conditions (operations) for respective steps in accordance with the characteristics.

Display layers of two types which differ from each other to a certain extent in terms of a liquid crystal composition (e.g., a display layer having large amounts of specific composition components, another display layer having small amounts of specific composition components, and the like) are formed, and characteristics of the display layers are determined in advance. As a result of this, a characteristic of a liquid crystal composition which is in the process of preparation can be estimated.

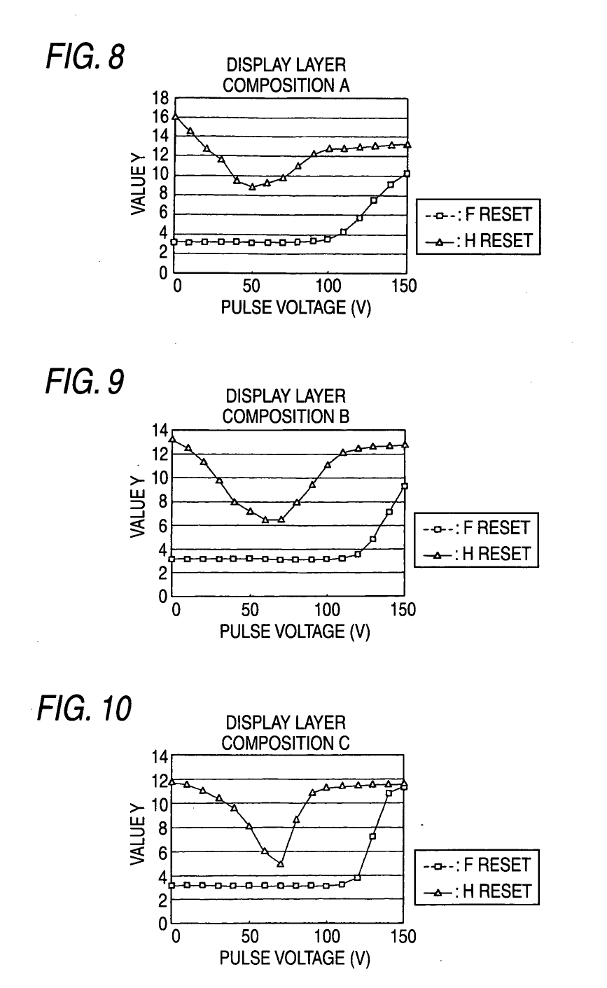

FIGS. 8, 9, and 10 show graphs showing a relationship of the magnitude of an adjustment voltage and reflectance of the display layer achieved after the liquid crystal composition of the display layer has been changed, in connection with three display layers (selective reflection layers); namely, a display layer composition A, a display layer composition B, and a display layer composition C, all of which are influenced in different ways by the adjustment voltage-applying operation. The significance of these graphs is the same as that of the graphs shown in FIGS. 1 and 2.

In relation to the display layer of the display layer composition A shown in FIG. 8 and the display layer of the display layer composition C shown in FIG. 10, the former display layer is higher than the latter display layer in terms of a dielectric constant, but is lower than the same in terms of resistance. Further, the latter display layer is lower in viscosity than the former display layer. The display layer of the display layer composition B in FIG. 9 is a fifty-fifty blend of the display layer composition A and the display layer composition C.

When the three graphs are compared with each other, the display layer of the display layer composition B is understood to exhibit intermediate characteristics between those of the display layer of the display layer composition A and those of the display layer of the display layer composition C.

Thus, the display layer exhibiting a desired reflection characteristic in response to the adjustment voltage can be realized.

### <Writing Apparatus>

In the present embodiment, the writing apparatus (an apparatus for driving the stacked optical modulation element) 2 is a device for writing an image on the display medium 1, and comprises, as a principal constituent element, a voltage application section (a power supply) 17 for applying a voltage to the display medium 1. Further, the writing apparatus is provided with a control circuit 16 for controlling the operation of the voltage application section.

### (Voltage Application Section)

The voltage application section (power supply) 17 has the function of applying a predetermined bias voltage to the display medium 1. The voltage application section may be of any circuit, so long as it can apply a desired voltage waveform to the display medium (between the respective electrodes) in accordance with an input signal from the control circuit 16. However, in this case, the circuit is required to produce an AC output and achieve a high through rate. In the present embodiment, there is a necessity for appropriately changing the frequency of a voltage to be applied (or applying a d.c. voltage) by means of writing operation performed at the lower threshold value, the adjustment voltage-applying operation, and writing operation performed at the higher threshold value. Accordingly, the frequency being variable (including 0 Hz) is indispensable. For instance, a bipolar high-voltage amplifier can be used for the voltage application section 17.

The power supply application section 17 applies a voltage to an area between the transparent electrodes 5, 6 of the display medium 1 via a contact terminal 19.

The contract terminal 19 is a member which contacts the voltage application section 17 and the display medium 1 (the transparent electrodes 5, 6) to thus bring them into mutual conduction, and has high conductivity. A contact terminal which exhibits small resistance upon contact with the transparent electrodes 5, 6 and the voltage application section 17 is selected. The contact terminal can have a structure for enabling separation of either the transparent electrodes 5, 6 and the voltage application section 17 or separation of the transparent electrodes 5, 6 and the voltage application section 17 from each other, so that the display medium 1 can be separated from the writing apparatus 2.

A terminal—which is formed from metal (e.g., gold, silver, copper, aluminum, or iron), carbon, a composite formed by dispersing metal and carbon in a polymer, a conductive polymer (e.g., a polythiophene-based conductive polymer or a polyaniline-based conductive polymer), and the like, and which assumes the shape of a clip or connector for pinching an electrode—is mentioned as the contact terminal 19.

### (Control Circuit)

The control circuit 16 is a member having the function of controlling operation of the voltage application section 17 in accordance with image data input from the outside (an image-capturing apparatus, an image receiver, an image processor, an image reproducing apparatus, an apparatus having a combination of these functions, or the like). Specific control operations of the control circuit 16 are embodied by processing pertaining to three operations (steps); namely, a “(first) writing operation (step),” an “adjustment voltage-applying operation (step),” and the “second writing operation (step),” all of which feature the present applied invention. Details of these operations will be described later.

### <Operation>

The method for driving a reflective liquid crystal display and actuation (operation) of the apparatus for driving the reflective liquid crystal display, both of which pertain to the present embodiment, are described in detail hereunder by reference to simple verification experiments.

In a case where characteristics of the influence of operation margins of the respective display layers and the influence of adjustment voltage-applying operation are evaluated, difficulty is encountered in observing changes in reflectance of each of the display layers if the two display layers have been stacked directly.

Therefore, in the verification experiment provided below, each of the display layers is formed alone, and the thus-formed display layers are electrically connected in series. Thus, changes in reflectance of each of the display layers and characteristics of the influence of operation margin on the adjustment voltage-applying operation are measured, thereby analogously evaluating the operation margin.

In the following experiment, a display layer of low dielectric constant and high resistivity is described as the display layer 7a; and a display layer of high dielectric constant and low resistivity is described as the display layer 7b.

The display layers 7a, 7b are formed into such a structure (having a thickness of 15 μm) that a pair of polyethylene terephthalate (PET)substrates, each having an ITO electrode (and a thickness of 125 μm), are provided opposite each other with the ITO electrodes facing inwardly and cholesteric liquid crystal of polymer dispersed type is sealed between the ITO electrodes.

Liquid crystal materials having different specific resistance values are used for the respective display layers 7a, 7b. Specifically, a liquid crystal material whose resistance value has been optimized by mixing fluorine-based liquid crystal into cyano-based liquid crystal is used for the display layer 7a of low dielectric constant and high resistivity. Cyano-based liquid crystal is used for the display layer 7b of high dielectric constant and low resistivity.

Since a slight capacitance difference must exist between the display layers 7a, 7b, the capacitance of the display layer 7a of low dielectric constant and high resistivity is set to 0.4 nF (50 Hz); and the capacitance of the display layer 7b of high dielectric constant and low resistivity is set to 0.6 nF (50 Hz). In order to control the influence of an operation margin on the adjustment voltage-applying operation, the liquid crystal composition of the display layer 7a and that of the display layer 7b are controlled. Specifically, a liquid crystal material—exhibiting low viscosity and high threshold steepness—is added to the display layer 7a, thereby enhancing sensitivity to an adjustment voltage.

### (Writing Operation and Adjustment Voltage-Applying Operation)

A rectangular-wave voltage (a reset pulse) (V1_{H}=150V and V1_{L}=60V) of 50 Hz (F_{V1}=50 Hz) is applied to the display layers 7a, 7b for 200 mS, thereby bringing the texture of the liquid crystal into a focal conic texture (an F reset) or a homeotropic texture (an H reset texture). Soon after, a DC pulse (having a frequency F_{V2}=0) of 10 mS is applied as an adjustment voltage V2 to the display layers 7a, 7b. At this time, verification is performed while the magnitude of the adjustment voltage V2 is switched within a range of 0V (i.e., without involvement of adjustment voltage-applying operation) to 150V in increments of 10V.

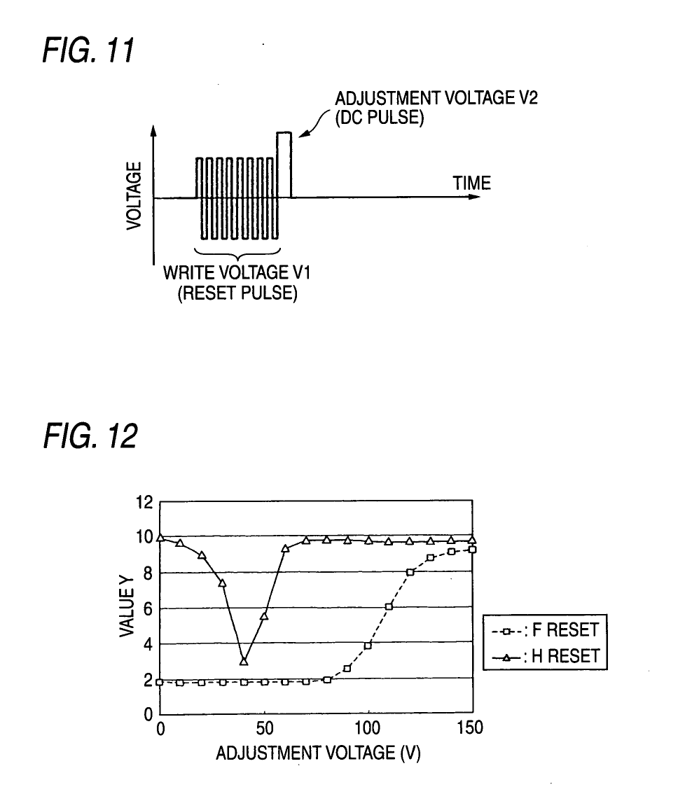

FIG. 11 is a chart showing, in time sequence, the waveform of a voltage applied during a period from the writing operation to the adjustment voltage-applying operation of the present embodiment. Voltages applied during the writing operation are of two types; namely, V1_{H} and V1_{L}. In this chart, the voltages are illustrated without being distinguished from each other.

As shown in FIG. 11, during verification, an adjustment voltage V2 of a DC pulse (a half pulse which is longer in pulse width than the write voltage) is applied continually, subsequent to application of the write voltage V1.

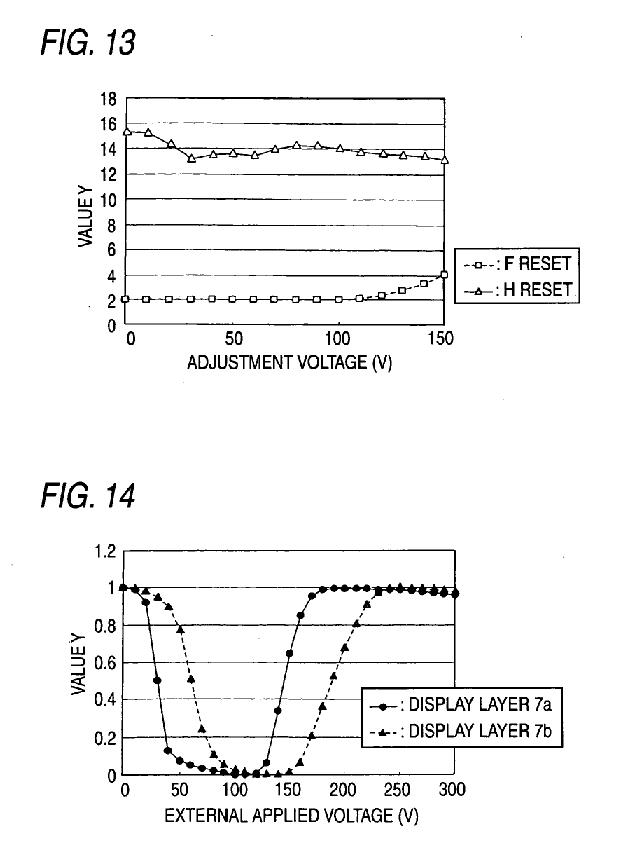

FIGS. 12 and 13 show graphs in which a relationship between measured luminous reflectance Y of an obtained display image and the magnitude of the adjustment voltage is plotted. FIG. 12 is a graph pertaining to the display layer 7a which is comparatively susceptible to the adjustment voltage-applying operation, and FIG. 13 is a graph pertaining to the display layer 7b which is comparatively less susceptible to the adjustment voltage-applying operation. In these drawings, two types of graphs achieved at the time of focal-conic (F) resetting and homeotropic (H) resetting are plotted in the writing operation.

As is evident from the graphs, the texture of the display layer 7a changes to a planar texture when the adjustment voltage V2 to be applied is 130V or thereabouts or more at the time of focal-conic resetting. In contrast, the display layer 7b retains the focal conic texture even when an adjustment voltage V2 of 130V or thereabouts is applied at the time of focal-conic resetting. Meanwhile, at the time of homeotropic resetting, the texture of the display layer 7a and that of the display layer 7b change to a planar texture by application of an adjustment voltage V2 of about 130V. The applied invention (A) is to make an attempt to essentially enlarge operation margin at the upper threshold value by utilization of a change in the characteristics of the display layers.

FIG. 4 shows switching behaviors of a combination of ideal display layers for which comparatively high margins are ensured at the upper and lower threshold values. In the present embodiment, display layers for which the operation margins for the upper threshold value are hardly ensured are provided in combination. FIG. 14 shows, in the form of graphs, switching behaviors of cholesteric liquid crystal of the respective display layers 7a, 7b of the display medium 1 of the present embodiment.

During operation performed at the upper threshold value, the texture of the display layer “b” having a high upper threshold voltage is selected to be a focal conic texture or a homeotropic texture. When application of a voltage is released, the homeotropic texture changes to the planar texture, and selective transmission realized by the focal conic texture and selective reflection realized by the planar texture are selected. At this time, a voltage having sufficiently exceeded the upper threshold voltage is applied to the display layer “a” having a low upper threshold voltage, and the texture of the display layer evenly changes to the homeotropic texture. When application of the voltage is released, the texture changes to a planar texture, and the entire surface of the display layer enters a reflecting state. If not, difficulty is encountered in driving the display layer under the threshold shifting method.

As can be seen from FIG. 14, the texture of the display layer “a” cannot sufficiently change to a homeotropic texture (the texture changes to a planar texture upon release of an applied voltage, and the display layer is in a reflecting state) at a voltage of about 100V to 150V where the display layer “b” enters a transmission state (a focal conic texture), in view of the value of reflectance (a value Y). For instance, substantially the entirety of the display layer “a” enters a focal-conic texture at an externally-applied voltage of 130V or less.

Specifically, even when an attempt is made to drive the display layer “b” at the upper threshold value, driving conditions for a write voltage which enable the display layer “a” to be evenly brought into a reflecting state are not found. The relationship between the display layer “a” and the display layer “b” is said to be in a state where the operation margin can hardly be ensured.

In the present embodiment, even in the case of a combination of display layers where an operation margin can hardly be ensured at the upper threshold value as mentioned above, an operation margin can be ensured substantially.

The way of the adjustment voltage actually acting on the display medium 1 shown in FIG. 3, which is acquired by stacking the display layers 7a, 7b, will be described hereunder.

First, it is assumed that a write voltage (300V), by means of which both the display layers 7a, 7b enter a homeotropic texture, is applied to the display layers, thereby bringing the display layers 7a, 7b into a homeotropic reset state; and that, immediately after the application of the write voltage, a DC pulse of about 260V is applied for 10 mS. In this case, an adjustment voltage V2 of about 130V is applied to each of the display layers 7a, 7b, and application of the voltage is released while the display layers remain in a homeotropic reset state, whereby the texture of both layers enters the planer texture (see FIGS. 12 and 13).

The adjustment voltage applied to each of the display layers 7a, 7b is divided by means of a capacitor ratio between the display layers 7a and 7b. In this case, the capacitance of the display layer 7b is set so as to become higher than the capacitance of the display layer 7a (i.e., a higher voltage is applied to the display layer 7a).

Meanwhile, it is assumed that the write voltage (120V), by means of which both the display layers 7a, 7b enter a focal conic texture, is applied to the display layers, thereby bringing the display layers into a focal-conic reset state; and that, immediately after application of the write voltage, a DC pulse of about 260V is applied to the display layers for 10 mS. Even in this case, the adjustment voltage V2 of about 130V is applied to each of the display layers 7a, 7b, and the display layer 7b maintains a focal conic texture. After the texture of the display layer 7a has changed to the homeotropic texture, the texture of the display layer 7a changes to a planar texture along with release of application of a voltage.

As mentioned above, the display layers 7a, 7b can be independently controlled by means of a single drive signal, by utilization of a difference in behaviors between the reset states of the respective display layers 7a, 7b. Thus, an operation margin for the upper threshold value can be substantially ensured.

Even when mere appropriate selection of the magnitude of the write voltage (300V or 120V) in the writing operation cannot prevent changing of the texture of the display layer 7a to an inappropriate texture, a state where selective reflection is realized by the planar texture and selective transmission is realized by the focal conic texture in the display layer 7b is maintained during the writing operation as a result of operation pertaining to the adjustment voltage-applying operation having been performed. Eventually, the entirety of the display layer 7a can be brought into a desired planar texture.

Actuation (operation) pertaining to the writing operation and the adjustment voltage-applying operation is summarized below by reference to FIG. 11.

:Writing Operation:

In the writing operation, a write voltage V1 of a single frequency F_{V1} is selectively applied, during a given period of time T_{V1}, in the form of two magnitudes; namely, a voltage V1_{H} exceeding the upper threshold value of the display layer 7b and a voltage V1_{L} not exceeding the upper threshold value, thereby selecting areas of the display layer 7b where the voltage does not exceed the upper threshold value and areas of the same where the voltage exceeds the upper threshold value. As a result, the areas of the display layer 7b —where the voltage exceeds the upper threshold value—enter a homeotropic texture; and the areas of the display layer 7b—where the voltage does not exceed the upper threshold value—enter a focal conic texture.

At this time, the entirety of the display layer 7a is desired to have remained in the homeotropic texture under a common threshold shifting method. However, in the present embodiment, the operation margin achieved at the upper threshold value is not ensured, and the homeotropic texture and the focal conic texture exist mixedly.

:Adjustment Voltage-Applying Operation:

In the adjustment voltage-applying operation in succession to the writing operation, the adjustment voltage V2, which is a direct current, is applied to the display layers 7a, 7b. The influence of the adjustment voltage V2 on the display layers 7a, 7b is described by reference to FIGS. 12 and 13. After application of an adjustment voltage V2, only the display layer 7a in a focal conic texture changes to a homeotropic texture. The display layer 7b intactly retains the selected homeotropic texture and the focal conic texture.

When the applied voltage is released, both the display layer “a” whose entirety remains in a homeotropic texture and the areas of the display layer “b” selected to remain in the homeotropic texture enter a planar texture. However, the areas of the display layer “b” selected to be in the focal conic texture remain intact. Namely, in connection with the display layer “b,” selection of reflection realized by the planar texture and transmission realized by the focal conic texture in the writing operation are retained in an unmodified manner.

Thus, the display layer 7b can be subjected to selective writing at the upper threshold value in the writing operation. The entirety of the display layer 7a can be brought into a planar texture in the adjustment voltage-applying operation. The display layer 7a is subjected to selective writing at the lower threshold value in a second writing operation that is subsequent to the writing operation.

### (Second Writing operation)

The above descriptions relate to the steps up to adjustment voltage-applying operation unique to the present invention. In relation to the applied invention, no problems arise, so long as operation pertaining to the subsequent second writing operation is performed by means of a known technique; that is, the threshold shifting method. It is desired to effect stable threshold shift driving while a sufficient operation margin is ensured at the lower threshold value even at the time of writing operation.

Therefore, in the present embodiment, a frequency F_{V3} of voltages (hereinafter sometimes called simply “second write voltages”) V3_{H} and V3_{L} applied during the course of operation performed in the second writing operation is made lower than the frequency F_{V1} of the write voltages V1_{H} and V1_{L} employed in the writing operation (F_{V3}<F_{V1}).

Actuation (operation) performed in the second writing operation of the present embodiment will now be described.

The display layers 7a, 7b are electrically connected in series, and a voltage pulse is applied from an external power supply capable of outputting an arbitrary waveform. During the operation performed at the lower threshold value, a rectangular pulse of 5 Hz is applied for 200 mS.

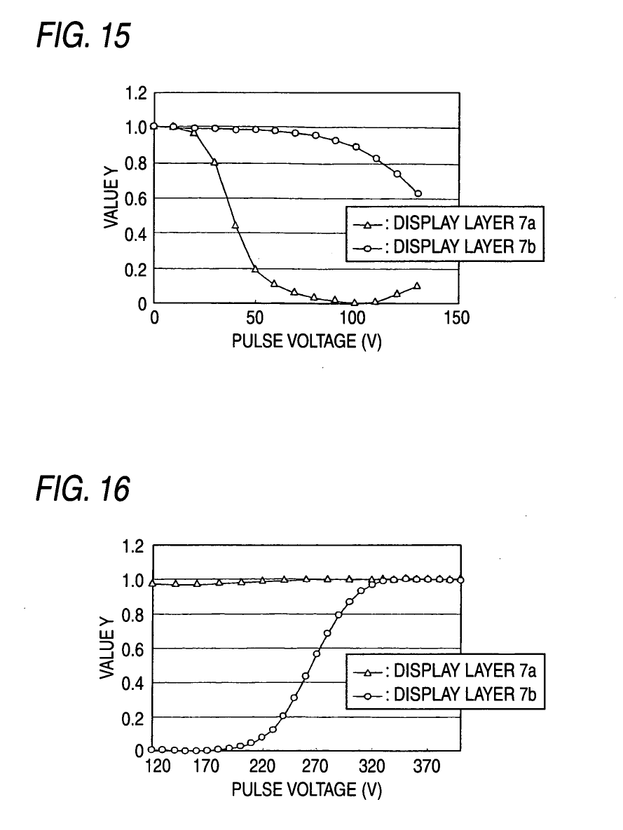

FIG. 15 shows, in the form of a graph, an optical characteristic achieved when a voltage of 5 Hz pulse is applied across the serially-connected display layers “a” and “b.” In FIG. 15, the vertical axis shows normalized values Y acquired when the maximum value Y of each of the display layers is taken as one and the minimum value Y of the same is taken as 0. The horizontal axis shows values of an applied pulse voltage. Measurement of the value Y is performed after application of the pulse voltage has been released. As can be seen from the graph shown in FIG. 15, a distinct deviation exists in the lower threshold values of the respective display layers 7a, 7b.

FIG. 16 shows, in the form of a graph, optical characteristics acquired when a pulse voltage of 50 Hz and an adjustment voltage of 260V are applied to both ends of the serially-connected display layers 7a, 7b. The vertical and horizontal axes shown in FIG. 16 are the same as those shown in FIG. 15. When the graph shown in FIG. 16 is viewed, the display layer “a” is always in a reflection state regardless of the magnitude of the pulse voltage, and only the display layer “b” responds to the pulse voltage. From this fact, it is understood that the operation margin of the upper threshold value can be sufficiently ensured by means of the effect of the adjustment voltage.

In the case of a comparatively-low-frequency pulse of the order of 5 Hz, the potential division ratio applied to each of the display layers is relaxed from a momentary capacitive division ratio to a resistive division ratio determined by a leakage current, and the influence of a difference between the resistance value of the display layer 7a and that of the display layer 7b appears. Since a greater voltage is applied to the display layer 7a of low dielectric constant and high resistance, an operation margin at the lower threshold value can be sufficiently ensured by means of making the operation threshold values of the respective display layers 7a, 7b different from each other.

Meanwhile, in the case of a comparatively-high-frequency pulse of the order of 50 Hz, the potential division ratio applied to the display layers 7a, 7b is not relaxed to the resistive division ratio. The capacitor ratio between the display layers 7a, 7b is expressed in an unmodified form as a potential division ratio. As mentioned previously, in relation to the upper threshold value, an operation margin is substantially ensured by means of the adjustment voltage-applying operation unique to the present invention. Accordingly, the essential requirement pertaining to the capacitor ratio between the display layers 7a, 7b is taken into consideration a potential division ratio of the adjustment voltage. There is no necessity for imparting a considerable difference of capacitance between the display layers.

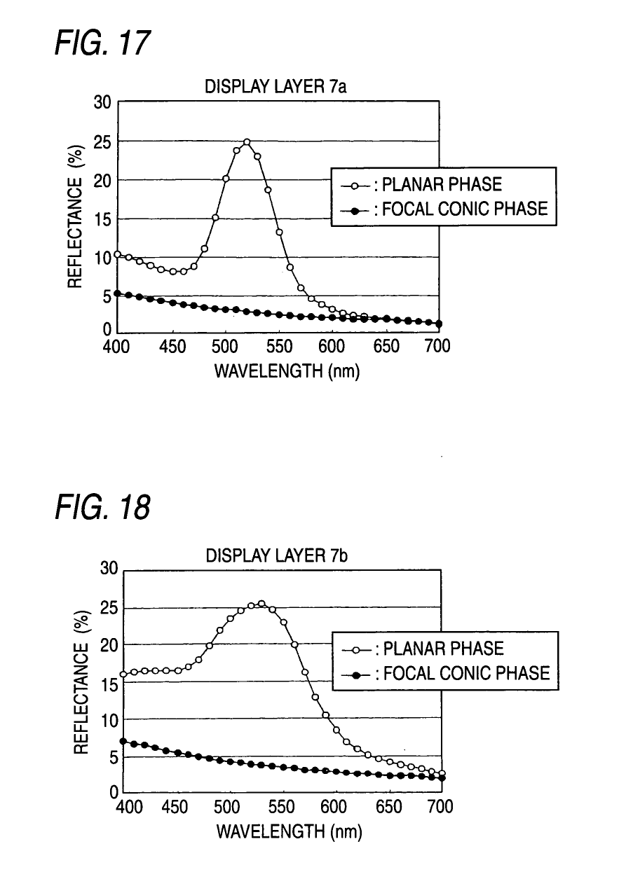

FIGS. 17 and 18 show reflection spectra of the above-created display layers 7a, 7b. High reflectance of about 25% is achieved in each of the display layers 7a, 7b. It can be shown by the above-mentioned verification experiment that threshold shift driving can be performed without impairing reflectance.

When the display medium 1 shown in FIG. 3 is acquired by means of stacking the two display layers 7a and 7b, operation pertaining to the “second writing operation” described below is performed in succession to operations pertaining to the previously-described “writing operation” and the “adjustment voltage-applying operation.” As a result, a sufficient operation margin is ensured for both the upper and lower threshold values while sufficient reflectance is imparted to the display layers. Thus, stable threshold shift driving is implemented.

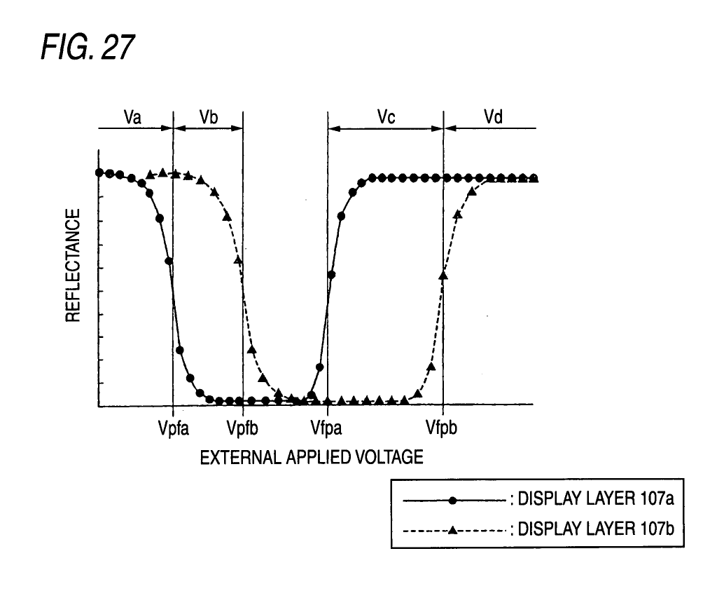

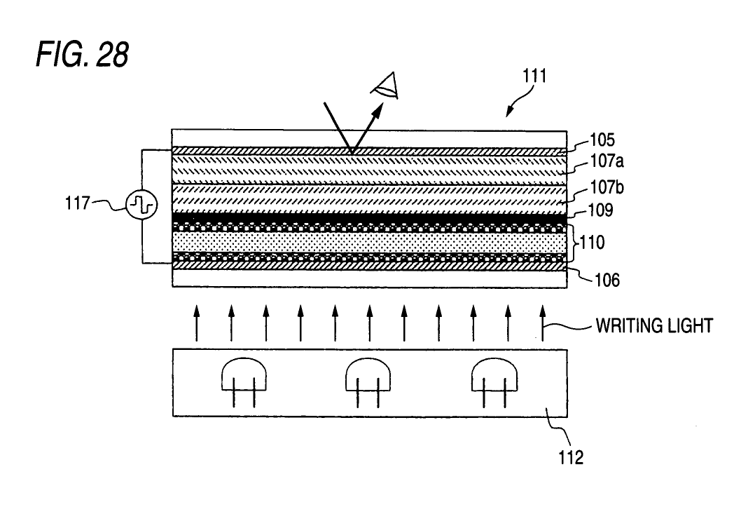

In the following descriptions, display layers 107a, 107b are described as if they were the display layers 7a, 7b of the present embodiment, by use of the graph of FIG. 27 employed in connection with the background art section. Strictly speaking, the graph is different in shape from that employed in the case of the display medium 1 formed by stacking the display layers 7a and 7b, but can be sufficiently substituted in order to describe operation of the respective steps.

A texture is selected for each of areas in the display layer 7b by means of the operation pertaining to the previously-described “writing operation” and the operation pertaining to the previously-described “adjustment voltage-applying operation.” After the entirety of the display layer 7a has been aligned to the planar texture, the voltage for the period Va, which is lower than the lower threshold value Vpfa of the display layer 7a, or the voltage for the period Vb, which is higher than the lower threshold value Vpfa of the display layer 7a and lower than the lower threshold value Vfpb of the display layer 7b, is selectively applied, in the form of a pulse waveform having a frequency of 5 Hz. In the areas of the display layer “a” applied with the voltage for the period Vb, the voltage exceeds the lower threshold value Vpfa, and the texture of the areas changes to a focal conic texture. In the areas of the display layer “a” applied with the voltage for the period Va, the voltage does not exceed the lower threshold value Vpfa, and the areas maintain the planar texture.

Meanwhile, in the display layer 7b, the voltage is lower than the lower threshold value Vfpb regardless of the magnitude of the applied voltage. Hence, the planer texture or the focal conic texture selected by the upper threshold value is maintained as mentioned previously.

In the second writing operation, a texture is selected for each of the areas of the display layer 7a.

Operation pertaining to the “writing operation,” operation pertaining to the 2“adjustment voltage-applying operation,” and operation pertaining to the “second writing operation” are sequentially performed. The magnitude of a voltage to be applied is selected for each of the voltage signals of two levels; namely, the upper and lower threshold values. In accordance with a combination of the voltages to be applied, an arbitrary one of the display layers 7a and 7b or both the display layers 7a and 7b can be brought into a reflection state; or both the display layers 7a and 7b can be brought into the transmission state. Thus, the texture is selected, and writing of an image to the reflective liquid crystal display (or driving of the reflective liquid crystal display) is performed.

As has been described above, in the present embodiment, in parallel with the liquid crystal composition of each of the display layers 7a, 7b being controlled, an appropriate adjustment voltage is applied to the display layers in the adjustment voltage-applying operation. Accordingly, the operation margin at the upper threshold value can be substantially enlarged, and stable threshold shift driving can be realized. Even at the lower threshold value, the frequency of a write voltage achieved in the second writing operation is reduced, to thus relax the capacitive division ratio to the resistive division ratio. Thus, the operation margin is enlarged, and stable threshold shift driving can be implemented.

Specifically, according to the present embodiment, operation margins at the upper and lower threshold values are enlarged while sufficient reflectance is being imparted to each of the display layers 7a, 7b, thereby enabling stable threshold shift driving.

### Second Embodiment

A second embodiment is an exemplary embodiment of the aspect (A) of the present invention in which the configuration of the present invention is applied to a method for driving an optical-writing, stacked, reflective liquid crystal display by means of a threshold shift method.

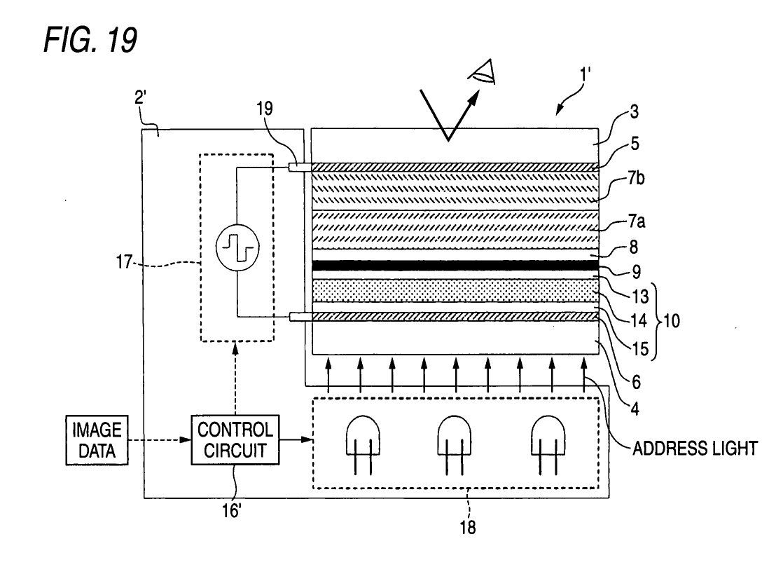

FIG. 19 is a schematic block diagram of a second embodiment which is an illustrative mode of a system to which the reflective liquid crystal display-driving method of the present invention is applied. As in the case of the first embodiment, the system of the present embodiment also comprises a display medium (a reflective liquid crystal display) 1′ and a writing apparatus (an apparatus for driving a reflective liquid crystal display) 2′. The present embodiment differs from the first embodiment in that a display medium including a photoconductive layer is used as a display medium (a reflective liquid crystal display) 1′. Accordingly, the configuration of a writing apparatus (an apparatus for driving a reflective liquid crystal display)2′ also becomes different.

The following descriptions chiefly provides differences between the first and second embodiments in terms of configuration, operation, and advantages. Those elements having the same functions as those of the first embodiment are assigned the same reference numerals, and their repeated explanations are omitted, as applicable.

### <Display Medium>

A display medium of the present embodiment is an element which enables selective driving of a plurality of liquid crystal layers (selective reflection layers) by means of exposure by an address light or application of a bias signal. Specifically, the display medium is a reflective liquid crystal display.

In the present embodiment, the display medium 1′ is a substance formed by means of stacking, in sequence from a display surface side, a transparent substrate 3; a transparent electrode 5; a display layer (a selective reflection layer) 7b; a display layer (a selective reflection layer) 7a; a laminate layer 8; a coloring layer (a light-shielding layer) 9; an OPC layer (a photoconductive layer) 10; a transparent electrode 6; and a transparent substrate 4. Specifically, the display medium 1′ has a structure in which the laminate layer 8, the coloring layer (a light-shielding layer) 9, and the OPC layer (a photoconductive layer) 10 are sandwiched between the first display layer (a selective reflection layer) 7a of the display medium 1 and the transparent electrode 6, both of which pertain to the first embodiment. Only these layers featured exclusively in the present embodiment will be described in detail hereunder.

### (OPC Layer)

The OPC layer (a photoconductive layer) 10 is a layer which has an internal photoelectric effect and whose impedance characteristic changes according to the intensity of radiation of address light. The OPC layer 10 can perform AC operation and must be symmetrically activated in response to the address light. The OPC layer is formed into a three-layer structure, wherein charge generation layers (CGL) are formed on upper and lower sides of a charge transport layer (CTL). In the present embodiment, an upper charge generation layer 13, a charge transport layer 14, and a lower charge generation layer 15 are stacked as the OPC layer 10 in sequence from an upper layer in FIG. 19.

The charge generation layers 13, 15 have the function of generating photo carriers by absorbing address light. The charge generation layer 13 controls the amount of photo carriers flowing from the transparent electrode 5 on the display surface side to the transparent electrode 6 on the write surface side. The charge generation layer 15 controls the amount of photo carriers flowing from the transparent electrode 6 on the write surface side toward the transparent electrode 5 on the display surface side. Used as the charge generation layers 13, 15 can be layers which generate excitons upon absorption of address light and efficiently separate the excitons into free carriers in the CGL or along an interface between the CGL and the CTL.

The charge generation layers 13, 15 can be generated by a dry process for directly forming a film of a charge generation material (e.g., metal or metal-free phthalocyanine; squalirium compounds; azulenium compounds; perylene pigments; indigo pigments; bis-azo pigments or tris-azo pigments; quinacridone pigments; pyrrolopyrrole dyes; polycyclic quinone pigments; fused aromatic pigments such as dibromo anthrone, and the like; cyanine dyes; xanthene pigments; charge-transfer complexes such as polyvinyl carbazole, nitrofluoren, and the like; and eutectic complexes formed from pyrylium-salt dye and polycarbonate resin); or a wet application method or the like for dispersing or dissolving the charge generation material into an appropriate solvent along with a polymeric binder (e.g., a polyvinyl butyral resin, a polyarylate resin, a polyester resin, a phenol resin, a vinylcarbazole resin, a vinyl formal resin, a partially-denatured vinyl acetal resin, a carbonate resin, an acrylic resin, a vinyl chloride resin, a stylene resin, a vinyl acetate resin, a silicone resin, and the like) to thus prepare a coating fluid, and applying and drying the coating fluid, to thus form a film.

The charge transport layer 14 has the function of being implanted with the photo carriers generated by the charge generation layers 13, 15 and drifting the photo carriers in the direction of the electric field applied by means of a bias signal. In general, the CTL has a thickness which is tens of times as large as that of the CGL. Hence, the contrast impedance of the entire OPC layer 10 is determined by the capacitance and a dark current of the charge transport layer 14 and the photo carrier current in the charge transport layer 14.

The charge transport layer 14 can be efficiently implanted with free carriers originating from the charge generation layers 13, 15 (the charge transport layer 14 can be close to the charge generation layers 13, 15 in terms of ionization potential), and the implanted free carriers can migrate in a hopping manner as fast as possible. In order to increase dark impedance, a lower dark current induced by hot carriers can be used.

The charge transport layer 14 is formed by means of dissolving or dispersing a low-molecular positive-hole transport material (e.g., trinitrofluorene-based compounds; polyvinyl-carbazole-based compounds; oxadiazole-based compounds; hydrazone-based compounds such as benzylamino-based hydrazone, quinoline-based hydrazone, or the like; stilbene-based compounds, triphenylamine-based compounds, triphenylmethane-based compounds, benzidine-based compounds) or a low-molecular electron transport material (e.g., quinone-based compounds, tetracyanoquinodimethane-based compounds, furfreon compounds, xanthone-based compounds, benzophenone-based compounds) into an appropriate solvent along with a polymeric binder (e.g., a polycarbonate resin, a polyalylate resin, a polyester resin, a polyimide resin, a polyamide resin, a polystyrene resin, a silicon-containing crosslinked resin, and the like), to thus prepare a coating fluid; and applying and drying the coating fluid.

### (Coloring Layer)

The coloring layer (the light-shielding layer) 9 is provided for the purpose of optically separating address light from incident light to thus prevent occurrence of malfunction, which would otherwise be caused by mutual interference between the address light and the incident light. In the present invention, the coloring layer is not an indispensable constituent element. In order to enhance the performance of the display medium 1′, the coloring layer is desirably provided. To this end, the coloring layer 9 is required to have the function of absorbing at least light in an absorption wavelength range of the CGL.

Specifically, the coloring layer 9 can be formed by means of applying inorganic pigments (e.g., cadmium-based pigments, chromium-based pigments, cobalt-based pigments, manganese-based pigments, carbon-based pigments) or organic dyes or organic pigments (azo-based pigments, anthraquinone-based pigments, indigo-based pigments, triphenylmethane-based pigments, nitro-based pigments, phthalocyanine-based pigments, perylene-based pigments, pyrrolopyrrole-based pigments, quinacridone-based pigments, polycyclic-quinone-based pigments, squarium pigments, azulenium pigments, cyanine-based pigments, pyrylium-based pigments, anthrone-based pigments) directly on the surface of the OPC layer 10 facing the charge generation layer 13 or dissolving or dispersing them into an appropriate solvent along with a polymeric binder (e.g., a polyvinyl alcohol resin, a polyacryl resin, and the like), to thus prepare a coating fluid; and applying and drying the coating fluid.

### (Laminate Layer)

The laminate layer 8 is formed from a polymeric material having a low glass transition point. A material which enables bonding and intimate contact between the display layers 7a, 7b and the coloring layer 9 by means of heat and pressure is selected for the laminate layer 8. Another requirement for the laminate layer 8 is to exhibit transmissivity to at least incident light and address light.

An adhesive polymeric material (e.g., an urethane resin, an epoxy resin, an acrylic resin, a silicone resin) can be mentioned as a material suitable for the laminate layer 8.

The laminate layer 8 is not an indispensable constituent element of the present invention.

### <Writing Apparatus>

The writing apparatus (the apparatus for driving a reflective liquid crystal display) 2′ of the present embodiment is an apparatus for writing an image on the display medium 1′, and comprises, as principal constituent elements, a light irradiation section (an exposure apparatus) 18 for radiating address light to the display medium 1′, and a voltage application section (a power supply) 17 for applying a bias voltage to the display medium 1′. Further, the writing apparatus is provided with a control circuit 16′ for controlling the operation of the voltage application section. Specifically, the writing apparatus 2 of the first embodiment is provided with the light irradiation section 18. The control circuit 16′ has the function of controlling the operation of the light irradiation section 18 along with operation of the voltage application section 17, as appropriate. Only the light irradiation section 18 and the control circuit 16′, both of which are features of the present embodiment, are described in detail hereunder.

### (Light Irradiation Section)

The light irradiation section (the exposure apparatus) 18 may be embodied as any section and is not susceptible to limitations, so long as the section has the function of radiating a predetermined address light pattern, which forms an image, on the display medium 1′ and is able to radiate a desired optical image pattern (a spectrum, intensity, and a spatial frequency) on a display medium 1′ (more specifically an OPC layer) in accordance with an input signal delivered from the control circuit 16.

Light complying with the following conditions can be selected as the address light radiated by the light irradiation section 18.

Spectrum: Higher energy in the absorption wavelength of the OPC layer 10 is desirable.

Radiation Intensity: Intensity at which the voltage applied to the respective display layers 7a, 7b during a bright period is divided by the OPC layer 10 to become greater than the upper and lower threshold voltages, thereby changing the texture of liquid crystal in the display layers 7a, 7b, but becoming equal to the upper and lower threshold voltages or less during a dark period.

Light desired to be the address light radiated by the light irradiation section 18 has peak intensity in an absorption wavelength of the OPC layer 10 and the narrowest band.

The following elements are mentioned as the light irradiation section 18.

(1-1) A uniform light source in which light sources (e.g., a cold-cathode tube, a Xenon lamp, a halogen lamp, an LED, an EL, and the like) are arranged in the form of an array or in which a light source and a light guide plate are combined together, and the like.

(1-2) A combination of light-modulating elements which generate a light pattern (e.g., an LCD, a photomask, and the like).

(2) A surface-emitting display (e.g., a CRT, a PDP, an EL, an LED, an FED, and an SED).

### (3) A combination of (1-1), (1-2) or (2) with an optical element (e.g., a microlens array, a SELFOC lens array, a prism array, and a view-angle adjustment sheet).

### (Control Circuit)

The control circuit 16′ is a member having the function of controlling operation of the voltage application section 17 and operation of the light irradiation section 18, as required, in accordance with the image data supplied from the outside (an image-capturing apparatus, an image receiver, an image processor, an image reproducing apparatus, an apparatus having a combination of these functions, or the like). Specific control operations of the control circuit 16′ are embodied by processing pertaining to three steps (operations); namely, a “writing operation (operation),” an “adjustment voltage-applying operation (operation),” and a “second writing operation (operation)” performed subsequent to the writing operation, all of which feature the present invention. Details of these operations will be described later.

### <Operation>

Even in the present embodiment, the verification experiment performed in the first embodiment, where the layered structure of the display layer is basically identical with that of the second embodiment, shows that threshold shifting driving operation can be sufficiently performed.

When a reflective liquid crystal display is obtained by means of stacking the two display layers 7a, 7b supplied for a verification experiment, operations pertaining to the “writing operation,” the “adjustment voltage-applying operation (operation),” and the “second writing operation,” all of which pertain to the reflective liquid crystal display (including a photoconductive layer) driving method of the present invention, are sequentially performed. As a result, a sufficient operation margin is ensured for the upper and lower threshold values while sufficient reflectance is being imparted to the display layers, and stable threshold shift driving is implemented.

### (Writing Operation)

First, a bias voltage (a reset voltage)—which is lower than the upper threshold voltage of the display layer 7b and higher than the upper threshold voltage of the display layer 7a—is applied, in the form of a pulse waveform having a frequency of 50 Hz, to all the display layers. Concurrently, the light irradiation section 18 selectively exposes the OPC layer 10 to address light, thereby changing (lowering) the resistance value of the OPC layer 10 in the exposed areas. Thus, the potential division between the display layers 7a, 7b is increased. In the exposed areas, the voltage applied to the display layers 7a and 7b exceeds the upper threshold value, and the texture of the display layer 7b changes to a homeotropic texture.

The voltage applied to the unexposed portions of the display layer 7b is Vc, and the display layer 7b enters a focal conic texture.

Meanwhile, both the exposed and unexposed areas of the display layer 7a enter a homeotropic texture. However, in reality, the operation margins of the two display layers cannot necessarily be ensured sufficiently. As in the case of the first embodiment, the display layers 7a, 7b for which no operation margin is ensured are used even in the present embodiment as shown in FIG. 14. Therefore, the homeotropic texture and the focal conic texture coexist in the display layer 7a.

### (Adjustment Voltage-Applying Operation)

In the adjustment voltage-applying operation performed in succession to the writing operation, the adjustment voltage V2, or a d.c. voltage, is continually applied to the display layers 7a, 7b. Since the influence of the adjustment voltage V2 on the display layers 7a, 7b is as has been described by reference to FIGS. 12 and 13 in the first embodiment, only the display layer 7a in the focal conic texture changes to the homeotropic texture after application of the adjustment voltage V2. The display layer 7b remains in the selected homeotropic texture and the selected focal conic texture.

At the time of release of application of the voltage, the display layer 7a whose entirety is in the homeotropic texture and the areas of the display layer 7b remaining in the homeotropic texture are changed to a planar texture. The areas of the display layer 7b remaining in the focal conic texture remain unchanged. In short, in the display layer 7b, the textures selected by means of reflection realized by the planar texture and transmission realized by the focal conic texture in the writing operation are maintained intact.

Thus, the display layer 7b can be subjected to selective writing at the upper threshold value in the writing operation. In the adjustment voltage-applying operation, the entirety of the display layer 7a can be brought to a planar texture. The display layer 7a is subjected to selective writing at the lower threshold value in the second writing operation subsequent to the writing operation.

### (Second Writing Operation)

The following descriptions are provided by use of the graphs in FIG. 27 employed in the background art section for the same reasons as those described in connection with the first embodiment.

After operation pertaining to the writing operation and operation pertaining to the adjustment voltage-applying operation have been performed, a bias voltage (a select voltage)—which becomes the voltage for the period Va that is lower than the lower threshold voltage Vpfa of the display layer 7a—is applied, in the form of a pulse waveform having a frequency of 5 Hz, to the entire display layers. Concurrently, the exposure apparatus selectively exposes the display layers to light, thereby increasing the potential division between the display layers 7a, 7b in the exposed areas, as in the case of the writing operation. Thereby, in the exposed areas, the voltage applied to the display layer 7a and the display layer 7b exceeds the lower threshold value Vpfa. The texture of the display layer 7a changes to a focal conic texture. Moreover, the voltage applied to the unexposed areas is Va, and hence the display layer 7a maintains the planar texture.

Meanwhile, all of the exposed and unexposed areas of the display layer 7b maintain the planar texture or the focal conic texture.

In the second writing operation, a texture is selected from one area to another in the display layer 7a in the manner as mentioned above.

Operation pertaining to the “writing operation,” operation pertaining to the “adjustment voltage-applying operation,” and operation pertaining to the “second writing operation,” which have been described thus far, are performed sequentially. Exposure/nonexposure is selected for each area while voltage signals of two levels; namely, the upper and lower threshold values, are being applied to the display layers. According to the combination of exposure with nonexposure, an arbitrary one or both of the display layers 7a, 7b can be brought into a reflection state; or both of the display layers can be brought into a transmission state. Thus, the textures are selected, and writing (driving) of the reflective liquid crystal display is performed.

As has been described above, in the present embodiment, the liquid crystal composition of each of the display layers 7a, 7b is controlled in the optical-writing, stacked, reflective liquid crystal display, and an appropriate adjustment voltage is applied to the display layers in the adjustment voltage-applying operation in accordance with the control of liquid crystal composition. Accordingly, the operation margin at the upper threshold value can be substantially enlarged, thereby realizing stable threshold shift driving. Moreover, even in relation to the lower threshold value, the frequency of the write voltage in the second writing operation is reduced, thereby relaxing the capacitive division ratio to the resistive division ratio to thus enlarge the operation margin. As a result, stable threshold shift driving can be implemented.

Specifically, according to the present embodiment, even in an optical-writing, stacked, and reflective liquid crystal display, the operation margin at the upper and lower threshold values is enlarged by means of imparting sufficient reflectance to each of the display layers 7a, 7b and realizing stable threshold shift driving.

### Third Embodiment

A third embodiment is an example applied invention (B) which is applied for the purpose of enhancing the contrast of a single-layer, optical-writing, and reflective liquid crystal display.

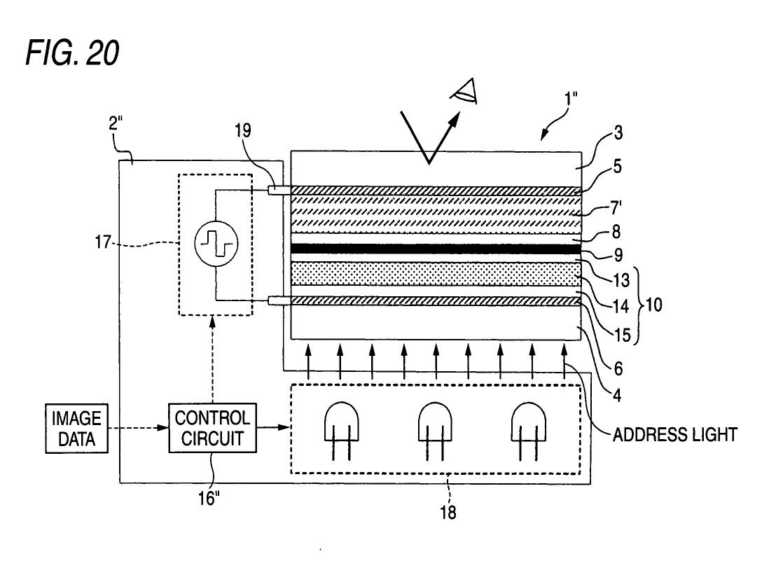

FIG. 20 is a schematic block diagram of a third embodiment which is an illustrative mode of a system to which the reflective liquid crystal display-driving method of the present invention is applied. As in the case of the first and second embodiments, the system of the present embodiment also comprises a display medium (a reflective liquid crystal display) 1″ and a writing apparatus (an apparatus for driving a reflective liquid crystal display) 2″. The present embodiment differs from the first embodiment in that a display medium—which includes a photoconductive layer and whose display layer (a selective reflection layer) of single-layer structure—is used for a display medium (a reflective liquid crystal display) 1.″ Accordingly, the configuration of a writing apparatus (an apparatus for driving a reflective liquid crystal display) 2″ also becomes different.

The following descriptions chiefly provide differences between the present embodiment and the first and second embodiments in terms of a configuration, operation, and advantages. Those elements having the same functions as those of the first and second embodiments are assigned the same reference numerals provided in the drawings, and their repeated explanations are omitted, as applicable.

### <Display Medium>

A display medium of the present embodiment is an element which enables selective driving of a single liquid crystal layer (a selective reflection layer) upon exposure by an address light and receipt of an applied bias signal. Specifically, the display medium is a reflective liquid crystal display.

In the present embodiment, the display medium 1″ is a substance formed by means of stacking, in sequence from a display surface side, the transparent substrate 3; the transparent electrode 5; a display layer (a selective reflection layer) 7′; the laminate layer 8; the coloring layer (the light-shielding layer) 9; the OPC layer (a photoconductive layer) 10; the transparent electrode 6; and the transparent substrate 4. Specifically, the display medium 1″ has a structure in which the two-layer structure of the display medium 1′ formed from the display layers 7a, 7b in the second embodiment is changed to the single layer; namely, the display layer 7′. Since the display layer 7′ is intrinsically identical with the display layers 7a and 7b, detailed descriptions of the layer are omitted here for brevity.

### <Writing Apparatus>

The writing apparatus is also identical with its counterpart of the second embodiment in terms of, particularly, a configuration, except that a control circuit 16″ performs control operation in such a way that the operation unique to the present embodiment is performed. Hence, detailed descriptions of the writing apparatus are omitted here for brevity.

Specific control operations performed by the control circuit 16″ are made up of only two steps (operations); namely, the “writing operation (step)” and the “adjustment voltage-applying operation (operation),” both of which are features of the present invention. Details of the control operations will be described later.

### <Operation>

The method for driving the reflective liquid crystal display and the apparatus for driving (operating) the reflective liquid crystal display, both of which pertain to the present embodiment, will be described hereunder by reference to a brief verification experiment.

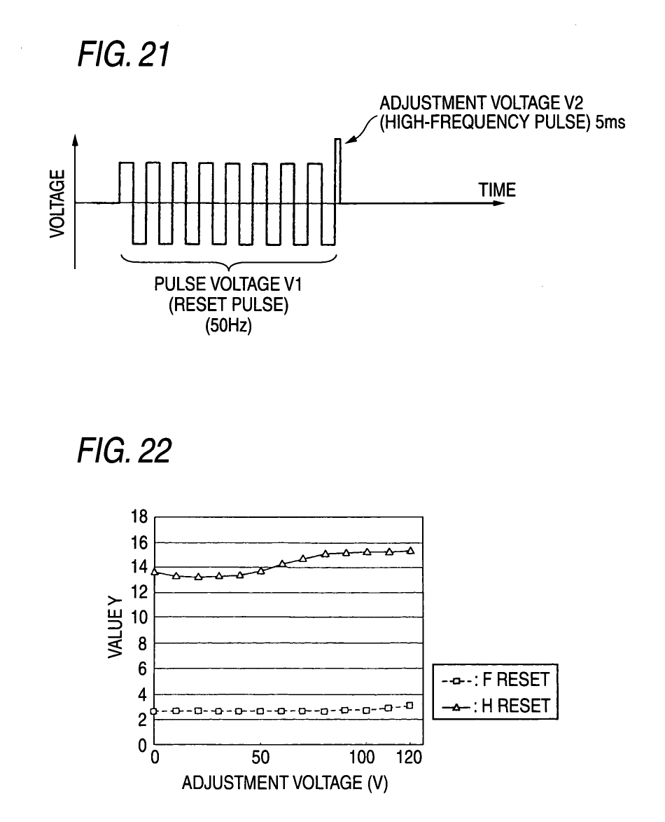

FIG. 21 is a chart showing, in time series, the waveform of an applied voltage in the writing operation and the adjustment voltage-applying operation in the present embodiment. As shown in FIG. 21, the adjustment voltage V2 of the DC pulse is applied subsequently to application of the write voltage V1 in this verification experiment.

First, in the writing operation, a bias voltage (a reset voltage) which is lower than the threshold voltage of the display layer 7′ is applied in the form of a pulse waveform having a frequency of 50 Hz pulse. Concurrently, the light irradiation section 18 selectively exposes the display layer to address light, thereby changing (lowering) the resistance value of the OPC layer 10 in exposed areas to thus increase potential division of the display layer 7′. Thereby, the voltage applied to the display layer 7′ in the exposed areas exceeds the threshold voltage, and the texture of the display layer 7′ changes to a homeotropic texture. The voltage applied to unexposed areas remains lower than the threshold voltage, and hence such areas enter a focal conic texture.

In succession to the writing operation, the adjustment voltage V2 in the form of a high-frequency short pulse is continually applied in the adjustment voltage-applying operation. In the present embodiment, immediately after application of a 50 Hz reset pulse in the writing operation, a DC pulse of 5 ms is applied as the adjustment voltage V2 in the adjustment voltage-applying operation. The wavelength of the 50 Hz reset pulse is 20 ms, but the adjustment voltage V2 is a considerably-short pulse.

After release of application of a voltage, the areas of the homeotropic texture change to a planar texture. The areas of the focal conic texture remain in their state.

FIG. 22 shows a graph representing a relationship between the value of an adjustment voltage and the luminous reflectance value Y, which is achieved when the adjustment voltage V2 in the adjustment voltage-applying operation is increased from 0V (without application of an adjustment voltage) to 130V in increments of 10V. In FIG. 22, there are plotted two graphs in relation to exposed areas remaining in a homeotropic texture (a homeotropic reset) and unexposed areas remaining in a focal conic texture (a focal conic reset).

As can be seen from the graph shown in FIG. 22, in relation to the homeotropic (H) reset, high reflectance is acquired when the DC pulse of 70V to 100V is applied as compared with the case where the DC pulse is not applied as an adjustment voltage (0V). Advantages and operation which are the same as those yielded when the display layer is driven through use of a high-frequency pulse for writing operation are presumed to have been induced by application of a high-frequency short pulse.

Thus far, the present invention has been described in detail by means of three exemplary embodiments. However, the present invention is not limited to these embodiments. The method and apparatus for driving the reflective liquid crystal display of the present invention provide adjustment voltage-applying operation; that is, a new reflectance control technique which is separate and different from and independent of drive operation for writing an image in the reflective liquid crystal display. By means of appropriately adjusting liquid crystal composition or requirements for applying an adjustment voltage, the influence of adjustment voltage-applying operation is controlled, thereby enhancing the diversity and controllability of driving of the reflective liquid crystal display. Therefore, any modification examples fall within the scope of the present invention, so long as the examples include an adjustment voltage-applying operation of applying a predetermined adjustment voltage subsequently to the writing operation.

The aspects (A) and (B) of the present invention, which are specific, effective utilization embodiments of the adjustment voltage-applying operation of the present invention, are also not limited to the above-described embodiments.

For instance, in relation to the aspect (A) of the present invention, only the reflective liquid crystal display—where the selective reflection layers (display layers) are double—is described as a specific example in the two embodiments; namely, the first and second embodiments. The number of selective reflection layers is not limited to two in the aspect (A) of the present invention but may be formed into three layers or more. So long as the selective reflection layers are formed into three layers to thus effect additive color mixture of coloring of the respective layers as blue, green, and red, a full-color image can be readily acquired by means of a simple drive technique embodied by the aspect (A) of the present invention.

In the case of a selective reflection layer of three-layer structure, the reflective liquid crystal display is configured by means of adjusting the upper and lower threshold values such that a difference arises in the upper and lower threshold voltages in each of the three layers. There will be briefly described operation performed when three selective reflection layers are arranged as a display layer “a,” a display layer “b,” and a display layer “c” in ascending sequence of threshold voltage.

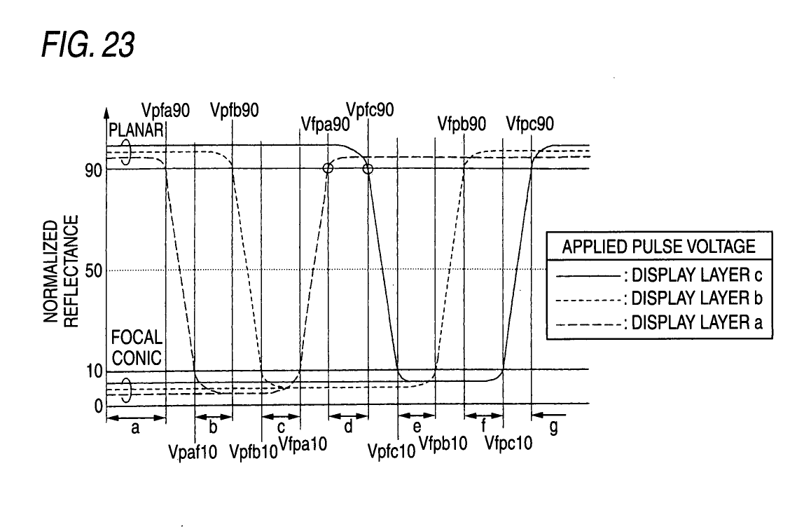

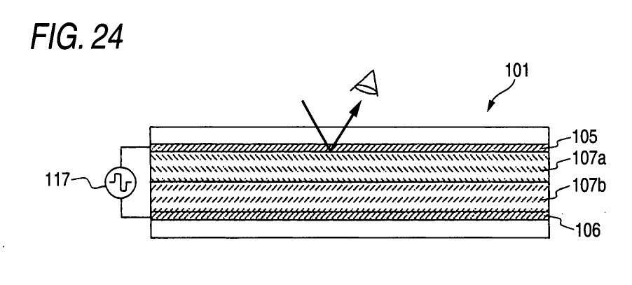

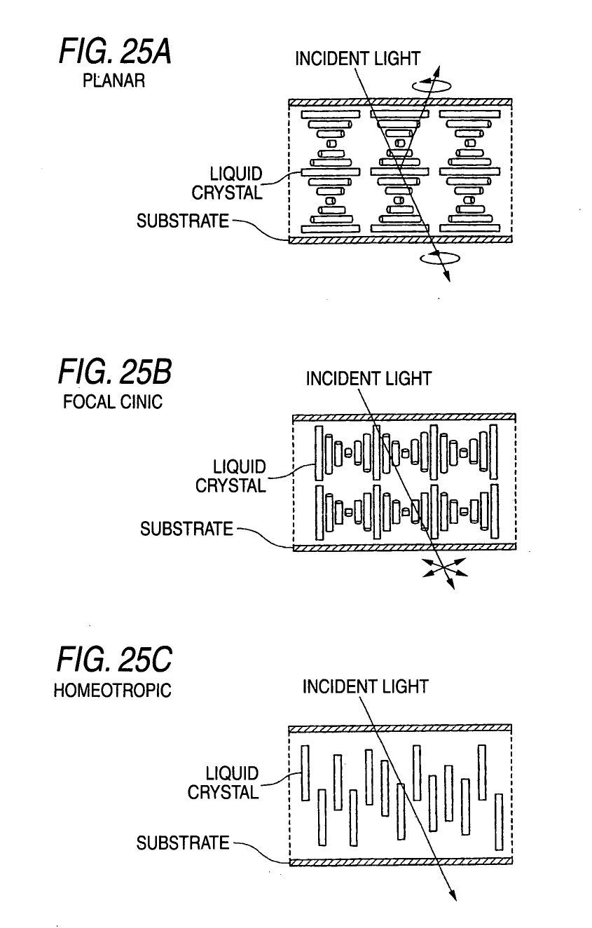

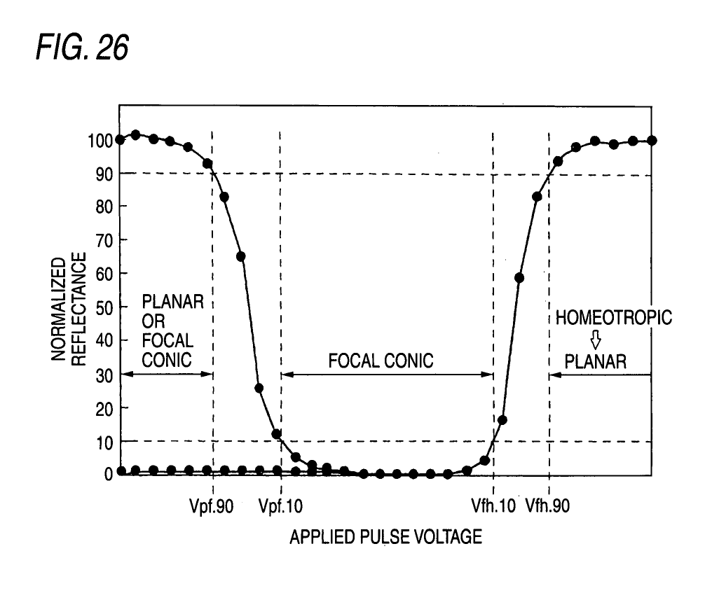

FIG. 23 is a graph showing ideal switching behaviors of cholesteric liquid crystal in the display layer “a,” the display layer “b,” and the display layer “c.” In order to facilitate explanation, the graph shown in FIG. 23 illustrates a combination of display layers for which the operation margins are ensured for the upper and lower threshold values. The lower threshold values Vpfa to Vpfc and the upper threshold values Vfpa to Vpfc are the same as those in FIG. 27 described in connection with the background art section. Numerals are affixed to alphabetical codes; the numerals designate normalized reflectance values.

In a general case irrelevant to the present invention, in order to drive a stacked, reflective liquid crystal element of three-layer configuration under the threshold shift method, a voltage is selected from seven voltages provided below, as required, in accordance with the intensity of light used for exposure, so that the respective reflection layer scan be switched from each other.
Voltage “a” in a range A of less than the lower threshold value Vpfa 90 of the display layer “a”
Voltage “b” which exceeds the voltage “a” and falls within a range B of less than the lower threshold value Vpfb 90 of the display layer “b”
Voltage “c” which exceeds the voltage “b” and falls within a range C of less than the upper threshold value Vfpa 10 of the display layer “a”
Voltage “d” which exceeds the voltage “c” and falls within a range D of less than the lower threshold value Vpfc 90 of the display layer “c”
Voltage “e” which exceeds the voltage “d” and falls within a range E of less than the upper threshold value Vfpb 10 of the display layer “b”
Voltage “f” which exceeds the voltage “e” and falls within a range F of less than the upper threshold value Vfpc 10 of the display layer “c”
Voltage “g” in a range G in excess of the upper threshold value Vfpc 90 of the display layer “c”

When the reflective liquid crystal display does not include a photoconductive layer, the voltage “e,” the voltage “f,” and the voltage “g” are selected and applied. Subsequently, the voltage “a,” the voltage “b,” the voltage “c,” and the voltage “d” are selected, as appropriate, and applied, to thereby select switching/non-switching of each of the selective reflection layers. Specifically, driving of the respective selective reflection layers can be selected by means of appropriately selecting the magnitude of a voltage to be applied from seven magnitudes. An image can be written simultaneously by means of a single signal.

Meanwhile, when the reflective liquid crystal display includes a photoconductive layer, the display element is exposed while being applied with the voltage “e” or “a,” thereby selecting switching or non-switching of each of the selective reflection layers. At this time, by means of selecting the intensity of exposure light from four types of light intensity, exposure intensity is designed so as to induce a texture change in the selective reflection layer of each desired threshold value.

By means of the above design, the switching states of three layers can be freely selected by means of single exposure. Specifically, exposure intensity is selected as appropriate from four types of exposure intensity levels while the applied voltage is maintained, thereby selecting driving of each of the selective reflection layers. An image can be written simultaneously by means of a single signal.

Since the above switching operation is performed at the respective upper and lower threshold values, operation pertaining to the writing operation (operation), operation pertaining to the adjustment voltage-applying operation, and processing pertaining to the second writing operation (operation) are performed as in the case of the first and second embodiments. A display layer (at least the display layer “a”; and the display layer “b” in some cases)—for which a texture state is not scheduled to be selected—must be in a homeotropic texture at the upper threshold value after operation pertaining to the writing operation (operation). When an operation margin cannot be sufficiently ensured, or the like, the configuration of the aspect (A) of the present invention is effective. A substantial operation margin can be ensured.

The following method is mentioned as a method for applying the aspect (A) of the present invention to drive the stacked reflective liquid crystal display of three-layer configuration by means of the threshold shift method.

The influence of adjustment voltage-applying operation on the display layer “a,” the display layer “b,” and the display layer “c” is appropriately controlled, to thus form a liquid crystal layer. Specifically, the display layers are made less susceptible to the influence of adjustment voltage-applying operation in sequence of the display layer “a,” the display layer “b,” and the display layer “c.”

First, in the writing operation (operation), there is applied a reset voltage which brings all of the display layers into a homeotropic texture or a focal conic texture. Immediately after application of the reset voltage, a DC pulse (adjustment voltage) is applied in the form of voltages of two magnitudes in the adjustment voltage-applying operation (operation).

When the homeotropic reset has been performed in the writing operation (operation), all of the display layers are brought into a planer texture regardless of application of the adjustment voltage.

When focal conic reset has been performed in the writing operation (operation), the display layers “a” and “b” enter a homeotropic texture at the time of application of a DC pulse of large voltage as the adjustment voltage, to thus finally enter a planar texture. The display layer “c” maintains a focal conic texture.

Similarly, when the focal conic reset is performed in the writing operation (operation) and when a DC pulse of small voltage is applied to the display layers, only the display layer “a” enters the homeotropic texture and finally enters a planar texture. The display layers “b” and “c” maintain a focal conic texture.

Specifically, in relation to the drive operation at the upper threshold value, the magnitude of an applied voltage is utilized in the adjustment voltage-applying operation featuring the present invention in place of selection of the texture of the common threshold shift method that encounters difficulty in ensuring an operation margin, thereby substantially enabling ensuring of the operation margin at the upper threshold value. Thereby, drive operation at the lower threshold value performed in the second writing operation (operation) is performed appropriately, and stable threshold shift driving can be implemented.

Particularly, in the case of a three-layer structure, an operation margin must be ensured among three layers. The freedom degree of selection of a material tends to become smaller. In order to ensure an operation margin at the upper threshold value as in the case of the applied invention, liquid crystal composition can be designed in consideration of solely the influence of the adjustment voltage-applying operation. The freedom degree of selection of a material is enlarged significantly, and a considerably wide operation margin can be ensured.

Specifically, as a matter of course, the aspect (A) of the present invention exhibits a superior advantage in spite of the two-layer structure. In the configuration of three or more layers where an operation margin among the respective layers is difficult to ensure, an excellent advantage can be said to be yielded.

No particular limitation is imposed on drive operation performed at the lower threshold value, and the essential requirement is to perform operation based on a general threshold shift method. However, when the operation margin at the lower threshold value is described to be ensured, the frequency of the applied voltage for the upper threshold value is made different from that for the lower threshold value, whereby the operation margin can be ensured at the lower threshold value without relying on capacitive division and by means of relaxing capacitive potential division to resistive potential division.

In this case, capacitive division is relaxed to resistive division, thereby liberating constraints on selection of a material imposed by a difference in dielectric constant or eliminating limitations. A material can be selected by means of a resistance ratio. Stable threshold shift driving is realized while all of the three layers are imparted with high reflectance. In short, in addition to the aspect (A) of the present invention, the frequency of an applied voltage for the upper threshold value is made different from that for the lower threshold value, thereby relaxing capacitive division to resistive division. By means of this, there is enlarged the range of choices of liquid crystal composition in a configuration of three or more layers where the operation margin among layers is difficult to ensure; particularly, in selective reflection layers. Further, controllability of driving operation is extended, and stable threshold shift driving can be implemented while high reflectance is imparted to the reflection layers.

In the aspect (A) of the present invention, the selective reflection layers are not limited to two layers or three layers. Even in the case of four or more selective reflection layers, switching of each of the selective reflection layers can be selected, as appropriate, by means of appropriately adjusting the magnitude of an applied voltage and the number of voltages (in a case where a photoconductor is not included) or appropriately adjusting the intensity of exposure and the number of light beams (in a case where the photoconductor is included). The greater the number of selective reflection layers, the more difficult the operation margin is to ensure. Accordingly, the aspect (A) of the present invention is particularly effective.

In addition, persons skilled in the art can alter, as appropriate, the present invention (including the aspects (A) and (B) of the present invention) in accordance with related-art, publicly-known knowledge. As a matter of course, any modifications fall within the scope of the present invention, so long as the modifications are equipped with the configuration of the present invention even after alterations have been made.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method for driving a reflective liquid crystal display to record an image on the reflective liquid crystal display, the reflective liquid crystal display comprising: a pair of electrodes; and a selective reflection layer sandwiched between the pair of electrodes, the selective reflection layer including a cholesteric liquid crystal and selectively reflecting light of a wavelength,
the method comprising:
selectively applying two or more kinds of voltages, which includes a voltage V1_{H} exceeding an operation threshold value of the selective reflection layer and a voltage V1_{L} not exceeding the operation threshold value of the selective reflection layer, to the selective reflection layer for a period of time T_{V1}, so as to select, in the selective reflection layer, an area where the operation threshold value is exceeded and other area where the operation threshold value is not exceeded; and
applying a voltage V2 to the selective reflection layer, the voltage V2 having a frequency differing from that of the voltages V1_{H} and V1_{L}.

2. The method according to claim 1, wherein the voltage V2 is a half-period pulse of one polarity.

3. The method according to claim 1, wherein the voltage V2 is applied to the selective reflection layer for a period of time T_{V2} shorter than the period of time T_{V1} during which the voltage V1_{H} and the V1_{L} are applied to the selective reflection layer.

4. The method according to claim 1, wherein
the reflective liquid crystal display comprising a plurality of selective reflection layers stacked without insertion of a electrode between the selective reflection layers, the plurality of selective reflection layers selectively reflecting light of different wavelengths in the visible light region and differing from one another in terms of: a lower threshold value serving as an operation threshold value for a voltage externally applied to induce a change of the cholesteric liquid crystal from a planar texture to a focal conic texture; and an upper threshold value serving as an operation threshold value for a voltage externally applied to induce a change of the cholesteric liquid crystal from a focal conic texture to a homeotropic texture,
the operation threshold value is the upper threshold value of a first selective reflection layer among the plurality of selective reflection layers, and the two or more kinds of voltages including the voltage V1_{H} and the voltage V1_{L} are applied to the plurality of selective reflection layers, so as to select, in each of the plurality of selective reflection layers, an area where the upper threshold value is exceeded and other area where the upper threshold value is not exceeded, and
the driving method further comprises applying two or more kinds of voltage, which includes a voltage V3_{H} exceeding the lower threshold value of a second selective reflection layer among the plurality of selective reflection layers other than the first selective reflection layer and a voltage V3_{L} not exceeding the lower threshold value of the second selective reflection layer, to the plurality of selective reflection layers, so as to select, in the plurality of selective reflection layers, an area where the lower threshold value is exceeded and other area where the lower threshold value is not exceeded.

5. The method according to claim 4, wherein
the reflective liquid crystal display further comprises a photoconductive layer stacked on one surface of the plurality of selective reflection layers, the photoconductive layer and the plurality of selective reflection layers being sandwiched between the pair of electrodes,
the applying of the two or more kinds of voltages including the voltage V1_{H} and the voltage V1_{L} is performed by selectively exposuring by an address light while applying a bias voltage V1 to the pair of electrodes, wherein the bias voltage V1 is divided into the voltage V1_{H} applied to the first selective reflection layer during exposure by the address light and the voltage V1_{L} applied to the first selective reflection layers during non-exposure by the address light, and
the applying of the two or more kinds of voltages including the voltage V3_{H} and the voltage V3_{L} is performed by selectively exposuring by the address light while applying a bias voltage V3 to the pair of electrodes, wherein the bias voltage V3 is divided into the voltage V3_{H} applied to the second selective reflection layer during exposure by the address light and the voltage V3_{L} applied to the second selective reflection layer during non-exposure by the address light.

6. The method according to claim 4, wherein the voltage V3_{H} and the voltage V3_{L} have a frequency F_{V3} lower than that of the voltage V1_{H} and the voltage V1_{L}.

7. The method according to claim 6, wherein the frequency F_{V3} of the voltage V3_{H} and the voltage V3_{L} is from 0 to 100 Hz.

8. The method according to claim 4, wherein the number of selective reflection layers is two or three.

9. The method according to claim 4, wherein the photoconductive layer comprises an organic photoconductor.

10. The method according to claim 1, wherein
the reflective liquid crystal display has the selective reflection layer of only one layer and further comprises a photoconductive layer stacked on the selective reflection layer, the photoconductive layer and the selective reflection layer being between the pair of electrodes,
the applying of the two or more kinds of voltages including the voltage V1_{H} and the voltage V1_{L} is performed by selectively exposing an address light while applying a bias voltage V1 to the pair of electrodes, wherein the bias voltage V1 is divided into the voltage V1_{H} applied to the selective reflection layer during exposure by the address light and the voltage V1_{L} applied to the selective reflection layer during non-exposure by the address light, so as to select, in the selective reflection layer, an area where the operation threshold value is exceeded and other area where the operation threshold value is not exceeded, and
the voltage V2 is applied to the selective reflection layer for a period of time T_{V2} shorter than the period of time T_{V1} during which the bias voltage V1 is applied to the selective reflection layer.

11. The method according to claim 10, wherein the photoconductive layer comprises an organic photoconductor.

12. The method according to claim 1, wherein the selective reflection layer comprises the cholesteric liquid crystal dispersed in a polymer.

13. An apparatus for driving a reflective liquid crystal display to record an image on the reflective liquid crystal display, the reflective liquid crystal display comprising: a pair of electrodes; and a selective reflection layer sandwiched between the pair of electrodes, the selective reflection layer including a cholesteric liquid crystal and selectively reflecting light of a wavelength,
the apparatus comprising a power supply capable of applying a voltage between the pair of electrodes, the apparatus sequentially performing:
a first writing operation of selectively applying two or more kinds of voltages, which includes a voltage V1_{H} exceeding an operation threshold value of the selective reflection layer and a voltage V1_{L} not exceeding the operation threshold value of the selective reflection layer, to the selective reflection layer for a period of time T_{V1}, so as to select, in the selective reflection layer, an area where the operation threshold value is exceeded and other area where the operation threshold value is not exceeded; and
an adjustment voltage-applying operation of applying a voltage V2 to the selective reflection layer, the voltage V2 having a frequency differing from that of the voltages V1_{H} and V1_{L}.

14. The apparatus according to claim 13, wherein the voltage V2 is a half wave of one pulse.

15. The apparatus according to claim 12, wherein
the reflective liquid crystal display comprising a plurality of selective reflection layers stacked without insertion of a electrode between the selective reflection layers, the plurality of selective reflection layers selectively reflecting light of different wavelengths in the visible light region and differing from one another in terms of: a lower threshold value serving as an operation threshold value for a voltage externally applied to induce a change of the cholesteric liquid crystal from a planar texture to a focal conic texture; and an upper threshold value serving as an operation threshold value for a voltage externally applied to induce a change of the cholesteric liquid crystal from a focal conic texture to a homeotropic texture,
the operation threshold value in the first writing operation is the upper threshold value of a first selective reflection layer among the plurality of selective reflection layers, and the first writing operation is performed by applying the two or more kinds of voltages including the voltage V1_{H} and the voltage V1_{L} to the plurality of selective reflection layers, so as to select, in each of the plurality of selective reflection layers, an area where the upper threshold value is exceeded and other area where the upper threshold value is not exceeded, and
the apparatus performs, in succession of the adjustment voltage-applying operation, a second writing operation of applying two or more kinds of voltage, which includes a voltage V3_{H} exceeding the lower threshold value of a second selective reflection layer among the plurality of selective reflection layers other than the first selective reflection layer and a voltage V3_{L} not exceeding the lower threshold value of the second selective reflection layer, to each of the plurality of selective reflection layers, so as to select, in each of the plurality of selective reflection layers, an area where the lower threshold value is exceeded and other area where the lower threshold value is not exceeded.

16. The apparatus according to claim 15, wherein the voltage V3_{H} and the voltage V3_{L} have a frequency F_{V3} lower than that of the voltage V1_{H} and the voltage V1_{L}.

17. The apparatus according to claim 16, wherein the frequency F_{V3} of the voltage V3_{H} and the voltage V3_{L} is from 0 to 100 Hz.

18. The apparatus according to claim 15, the number of selective reflection layers is two or three.

19. The apparatus according to claim 13, wherein the selective reflection layer comprises the cholesteric liquid crystal dispersed in a polymer.

20. An apparatus for driving a reflective liquid crystal display to record an image on the reflective liquid crystal display, the reflective liquid crystal display comprising: a pair of electrodes; a plurality of selective reflection layers stacked without insertion of a electrode between the selective reflection layers, the plurality of selective reflection layers selectively reflecting light of different wavelengths in the visible light region and differing from one another in terms of: a lower threshold value serving as an operation threshold value for a voltage externally applied to induce a change of the cholesteric liquid crystal from a planar texture to a focal conic texture; and an upper threshold value serving as an operation threshold value for a voltage externally applied to induce a change of the cholesteric liquid crystal from a focal conic texture to a homeotropic texture; and a photoconductive layer stacked on one surface of the plurality of selective reflection layers, the photoconductive layer and the plurality of selective reflection layers being sandwiched between the pair of electrodes,
the apparatus comprising a power supply capable of applying a voltage between the pair of electrodes, the apparatus sequentially performing:
a first writing operation of selectively exposing to an address light while applying a bias voltage V1 to the pair of electrodes for a period of time T_{V1}, wherein the bias voltage V1 is divided into the voltage V1_{H} and the voltage V1_{L}, the voltage V1_{H} exceeds an upper threshold value of a first selective reflection layer among the plurality of selective reflection layers during exposure by the address light and the voltage V1_{H} does not exceed the upper threshold value during non-exposure by the address light;
an adjustment voltage-applying operation of applying a voltage V2 to the plurality of selective reflection layers, the voltage V2 having a frequency differing from that of the voltages V1; and
a second writing operation of selectively exposing to an address light while applying a bias voltage V3 to the pair of electrodes so as to select, in each of the plurality of selective reflection layers, an area where a lower threshold value of a second selective reflection layer among the plurality of selective reflection layers other than the first selective reflection layer is exceeded and other area where the lower threshold value is not exceeded, wherein the bias voltage V3 is divided into the voltage V3_{H} and the voltage V3_{L}, the voltage V3_{H} exceeds the lower threshold value during exposure by the address light, and the voltage V3_{L} does not exceeding the lower threshold value of the second selective reflection layer during non-exposure by the address light.

21. The apparatus according to claim 20, wherein the voltage V3_{H} and the voltage V3_{L} have a frequency F_{V3} lower than that of the voltage V1_{H} and the voltage V1_{L}.

22. The apparatus according to claim 21, wherein the frequency F_{V3} of the voltage V3_{H} and the voltage V3_{L} is from 0 to 100 Hz.

23. The apparatus according to claim 20, the number of selective reflection layers is two or three.

24. The apparatus according to claim 20, wherein the photoconductive layer comprises an organic photoconductor.

25. The apparatus according to claim 20, wherein the plurality of selective reflection layers each comprises the cholesteric liquid crystal dispersed in a polymer.

26. The apparatus according to claim 13, wherein
the reflective liquid crystal display has the selective reflection layer of only one layer and further comprises a photoconductive layer stacked on the selective reflection layer, the photoconductive layer and the selective reflection layer being between the pair of electrodes,
the first writing operation is performed by selectively exposing to an address light while applying a bias voltage V1 to the pair of electrodes, wherein the bias voltage V1 is divided into the voltage V1_{H} applied to the selective reflection layer during exposure by the address light and the voltage V1_{L} applied to the selective reflection layer during non-exposure by the address light, so as to select, in the selective reflection layer, an area where the operation threshold value is exceeded and other area where the operation threshold value is not exceeded, and
the voltage V2 in the adjustment voltage-applying operation is applied to the selective reflection layer for a period of time T_{V2} shorter than the period of time T_{V1} of the voltage V1 in the first writing operation.

27. The apparatus according to claim 26, wherein the photoconductive layer comprises an organic photoconductor.

28. The apparatus according to claim 26, wherein the selective reflection layer comprises the cholesteric liquid crystal dispersed in a polymer.
